(19) United States
(12) Patent Application Publication
(10) Pub. No.: US 2026/0264574 A1
(43) Pub. Date: Sep. 10, 2026

(54) FUEL CELL SYSTEM AND METHOD OF OPERATING THE FUEL CELL SYSTEM

(71) Applicant: VOLVO TRUCK CORPORATION, Göteborg (SE)

(72) Inventors: Pranav ARYA, Lindome (SE); Ricard BLANC, Mölndal (SE)

(73) Assignee: VOLVO TRUCK CORPORATION, Göteborg (SE)

(21) Appl. No.: 19/167,105

(22) PCT Filed: Mar. 20, 2023
(86) PCT No.: PCT/EP2023/057106

§ 371 Date: Sep. 19, 2025

(51) Int. Cl. B60L 58/33; B60L 50/70; H01M 8/04029; H01M 8/04223; H01M 8/04228; H01M 8/04302; H01M 8/0432; H01M 8/10

(52) U.S. Cl. CPC B60L 58/33; B60L 50/70; H01M 8/04029; H01M 8/04228; H01M 8/04253; H01M 8/04302; H01M 8/0432; B60L 2250/00; H01M 2008/1095; H01M 2250/20

(57) ABSTRACT

A fuel cell vehicle has a fuel cell system, a cooling system, and a control system comprising processing circuitry configured to control operation of the fuel cell system. The processing circuitry is configured to estimate a duration of a stopover of the vehicle; and, responsive to determining that the fuel cell system needs to be shut down during the stopover, that a freeze preparation of the fuel cell system is required, that the vehicle is expected to be occupied by a vehicle user during the stopover and/or that is possible to perform the freeze preparation at a time of the shutdown of the fuel cell system, perform a forced freeze preparation of the fuel cell system at the time of the shutdown of the fuel cell system. An auxiliary cooling subsystem of the cooling system may be used to assist a primary cooling subsystem in cooling the fuel cell system.

### TECHNICAL FIELD

The disclosure relates generally to operating a fuel cell system in a fuel cell vehicle. In particular, the disclosure relates to selectively performing a freeze preparation of the fuel cell system during a stopover of the vehicle.

The disclosure can be applied in heavy-duty vehicles, such as trucks, buses, and construction equipment. Although the disclosure may be described with respect to a particular vehicle, the disclosure is not restricted to any particular vehicle.

### BACKGROUND

In a fuel cell vehicle, one or more fuel cell systems, typically in combination with an electrical energy storage system such as batteries, are used for powering the vehicle. The fuel cell system comprises one or more, and typically hundreds of fuel cells forming a fuel cell stack for generating the desired propulsion power supplied to the vehicle. A fuel cell is an electrochemical device that includes an electrolyte sandwiched between two electrodes such as an anode and a cathode. The fuel cell converts the chemical energy of a fuel, typically hydrogen, and an oxidizing agent, typically oxygen or air, into electricity. Fuel cells are increasingly considered for powering electric vehicles, such as pure electric vehicles and hybrid electric vehicles.

Fuel cell systems may be subjected to repeated on-off duty cycles involving periods of inactivity for varied lengths of time and at varied temperatures. It is generally desirable to be able to reliably start-up fuel cell systems in a short period of time. For example, in automotive applications, to meet driver expectations and for safety reasons, it is required to start a fuel cell system reliably and sufficiently quickly, at any ambient temperature, including below-zero temperatures. At the same time, fuel cell systems are quite sensitive to cold temperatures, and below-freezing temperatures cause damage to a fuel cell system, particularly during the system start-up.

Various methods have been proposed for storing and starting-up fuel cells in anticipation of below freezing ambient conditions. For example, a freeze preparation may be performed by expelling or purging water from inside a fuel cell system, so as to prevent any freezing and thus damage inside the system.

However, despite current developments, there remains a need in improved techniques for appropriate managing of fuel cell systems in below-zero temperature conditions and in anticipation of such conditions.

### SUMMARY

According to an aspect of the disclosure, a fuel cell vehicle is provided that comprises a fuel cell system comprising a fuel cell stack, and a cooling system comprising a primary cooling subsystem configured to reduce a temperature of the fuel cell stack to an ambient temperature, and an auxiliary cooling subsystem configured to assist the primary cooling subsystem to reduce the temperature of the fuel cell stack to below the ambient temperature. The fuel cell vehicle also comprises a control system comprising processing circuitry configured to:
estimate a duration of a stopover of the vehicle when a request for the stopover of the vehicle is detected;
determine whether the fuel cell system needs to be shut down during the stopover;
responsive to determining that the fuel cell system needs to be shut down during the stopover, determine whether a freeze preparation of the fuel cell system is required during the stopover;
responsive to determining that the freeze preparation of the fuel cell system is required during the stopover, determine whether the vehicle is expected to be occupied by a vehicle user during at least part of the duration of the stopover; and
responsive to determining that the vehicle is expected to be occupied by the vehicle user during at least part of the duration of the stopover, perform a forced freeze preparation at a time of the shutdown of the fuel cell system.

Accordingly, responsive to determining that the fuel cell system needs to be shut down during the stopover, a freeze preparation of the fuel cell system is required, and the vehicle is expected to be occupied by a vehicle user during the stopover, a forced freeze preparation of the fuel cell system is performed at a time of the shutdown of the fuel cell system. There is thus no need to keep at least some functions of the control system of the fuel cell system fully activated. The control system may be a fuel cell controller configured to control operation of the fuel cell system, a vehicle controller or system configured to control operation of various components of the vehicle (which may include the fuel cell system), or any other control system such as e.g. a control system configured to perform one or more functions of the fuel cell controller and one or more functions of the vehicle control system. A technical benefit of avoiding a need to keep all functions of the control system up and running includes saving energy and thus operating the fuel cell system, and the entire vehicle, in a more cost-effective manner. In addition, performing the freeze preparation of the fuel cell system requires having operational at least some other components of a high-voltage (HV) system of the vehicle, in addition to the fuel cell system. This also requires energy resources. The methods and systems of the present disclosure allow further saving energy by deactivating or not activating certain components of the vehicle such as the HV system.

Another benefit of performing the so-called forced freeze preparation is that the driver, if present in the vehicle and e.g. sleeping in a vehicle cabin, will not be disturbed since the freeze preparation is performed beforehand and a noise/sound from a running compressor what would otherwise disturb the driver is not present.

In some examples, the processing circuitry of the control system is further configured to, responsive to determining that the vehicle is not expected to be occupied by the vehicle user during at least part of the duration of the stopover, determine whether it is possible to perform the freeze preparation of the fuel cell system, and, responsive to determining that it is possible to perform the freeze preparation, perform the forced freeze preparation of the fuel cell system at the time of the shutdown of the fuel cell system.

In some examples, the processing circuitry is further configured to perform the forced freeze preparation at the time of the shutdown of the fuel cell system by instructing the fuel cell system to shut down, optionally activating the auxiliary cooling subsystem, reducing the temperature of the fuel cell system below a first threshold level using one or both the primary cooling subsystem and the auxiliary cooling subsystem, and performing the freeze preparation of the fuel cell system.

In some examples, the processing circuitry of the control system is further configured to, responsive to determining that it is not possible to perform the freeze preparation of the fuel cell system, determine whether it is possible to subsequently perform a wake-up of the fuel cell system during the stopover to perform the freeze preparation of the fuel cell system.

In some examples, the fuel cell vehicle comprises a vehicle control system configured to control operation of the control system. In some examples, the control system and the vehicle control system may be part of a same control system.

In some examples, the processing circuitry is further configured to at least partially deactivate a monitoring unit of the control system and/or at least partially deactivate a monitoring unit of the vehicle control system.

In some examples, the processing circuitry is further configured to, responsive to determining that it is possible to subsequently perform the wake-up of the fuel cell system to perform the freeze preparation of the fuel cell system, shut down the fuel cell system without performing a freeze preparation.

In some examples, the processing circuitry is further configured to monitor an ambient temperature and a temperature of the fuel cell system, with the fuel cell system being shut down; determine, based on the monitoring, whether the temperature of the fuel cell system is below a second threshold level; and responsive to determining that the temperature of the fuel cell system is below the second threshold level, perform a wake-up of the fuel cell system and perform the freeze preparation after the wake-up of the fuel cell system.

In some examples, the processing circuitry is further configured to activate the monitoring unit of the control system configured to monitor the ambient temperature and the temperature of the fuel cell system.

In some examples, determining whether the freeze preparation of the fuel cell system is required during the stopover of the vehicle is based on a predicted and/or current ambient temperature and/or a thermal model of the fuel cell system.

In some examples, the duration of the stopover of the vehicle is determined based on one or more out of a location of the vehicle, historical data on operation of the vehicle, and input from a driver of the vehicle.

In some examples, the processing circuitry is further configured to, responsive to determining that the fuel cell system does not need to be shut down during the stopover of the vehicle, continuing operating the fuel cell system.

In some examples, the processing circuitry is further configured to, responsive to determining that the fuel cell system needs to be shut down during the stopover and responsive to determining that the freeze preparation of the fuel cell system is not required during the stopover, shutting down the fuel cell system.

According to an aspect of the disclosure, a method of controlling operation of a fuel cell system of a fuel cell vehicle is provided, the method comprising:
estimating a duration of a stopover of the vehicle when a request for the stopover of the vehicle is detected;
determining whether the fuel cell system needs to be shut down during the stopover;
responsive to determining that the fuel cell system needs to be shut down during the stopover, determining whether a freeze preparation of the fuel cell system is required during the stopover;
responsive to determining that the freeze preparation of the fuel cell system is required during the stopover, determining whether the vehicle is expected to be occupied by a vehicle user during at least part of the duration of the stopover; and
responsive to determining that the vehicle is expected to be occupied by the vehicle user during at least part of the duration of the stopover, performing a forced freeze preparation at a time of the shutdown of the fuel cell system.

In some examples, the method further comprises, responsive to determining that the vehicle is not expected to be occupied by the vehicle user during at least part of the duration of the stopover, determining whether it is possible to perform the freeze preparation of the fuel cell system, and, responsive to determining that it is possible to perform the freeze preparation, performing the forced freeze preparation of the fuel cell system at the time of the shutdown of the fuel cell system. The determining of whether it is possible to perform the freeze preparation of the fuel cell system at the time of the shutdown of the fuel cell system may comprise determining whether it is possible to reduce a temperature of the fuel cell system to below a first threshold level.

In some examples, performing the forced freeze preparation of the fuel cell system at the time of the shutdown of the fuel cell system comprises instructing the fuel cell system to shut down, reducing the temperature of the fuel cell system below a first threshold level using a primary cooling subsystem of a cooling system of the fuel cell vehicle or using both the primary cooling subsystem and an auxiliary cooling subsystem of the cooling system of the fuel cell vehicle, and performing the freeze preparation. The performing of the forced freeze preparation may comprise activating the auxiliary cooling subsystem of the cooling system of the fuel cell vehicle.

In some examples, the fuel cell vehicle comprises a vehicle control system configured to control operation of the control system. In some examples, the control system and the vehicle control system may be part of a same control system.

In some examples, the method further comprises at least partially deactivating a monitoring unit of the control system and/or at least partially deactivating a monitoring unit of the vehicle control system.

In some examples, the method further comprises, responsive to determining that it is not possible to perform the freeze preparation of the fuel cell system, determining whether it is possible to subsequently perform a wake-up of the fuel cell system during the stopover to perform the freeze preparation of the fuel cell system.

In some examples, the method further comprises, responsive to determining that it is possible to subsequently perform the wake-up of the fuel cell system to perform the freeze preparation of the fuel cell system, shutting down the fuel cell system without performing a freeze preparation.

In some examples, the method further comprises monitoring an ambient temperature and a temperature of the fuel cell system, with the fuel cell system being shut down; determining, based on the monitoring, whether the temperature of the fuel cell system is below a second threshold level; and, responsive to determining that the temperature of the fuel cell system is below the second threshold level, performing a wake-up of the fuel cell system; and performing the freeze preparation after the wake-up of the fuel cell system.

In some examples, the method further comprises activating the monitoring unit of the control system configured to monitor the ambient temperature and the temperature of the fuel cell system.

In some examples, in the method, the determining whether the freeze preparation of the fuel cell system is required during the stopover of the vehicle is based on a predicted and/or current ambient temperature and/or a thermal model of the fuel cell system.

In some examples, the duration of the stopover of the vehicle is determined based on one or more out of a location of the vehicle, historical data on operation of the vehicle, and input from a driver of the vehicle.

In some examples, the method further comprises, responsive to determining that the fuel cell system does not need to be shut down during the stopover of the vehicle, continuing operating the fuel cell system.

In some examples, the method further comprises, responsive to determining that the fuel cell system needs to be shut down during the stopover and responsive to determining that the freeze preparation of the fuel cell system is not required during the stopover, shutting down the fuel cell system.

According to an aspect of the disclosure, a control system is provided for controlling the fuel cell system of the fuel cell vehicle, the control system comprising processing circuitry that is configured to perform the method in accordance with examples of the present disclosure.

According to an aspect of the disclosure, a fuel cell system comprising the control system and/or configured to communicate with the control system is provided, the control system comprising processing circuitry that is configured to perform the method in accordance with examples of the present disclosure.

According to an aspect of the disclosure, a computer program product comprising instructions, which, when executed by processing circuity, cause the processing circuity to perform the method in accordance with examples of the present disclosure.

According to an aspect of the disclosure, a computer-readable storage medium is provided. The computer-readable storage medium has stored thereon a computer program product comprising instructions which, when executed by processing circuity, cause the processing circuity to perform the method in accordance with examples of the present disclosure.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control systems, units, computer readable media, and computer program products associated with the above discussed technical benefits.

### BRIEF DESCRIPTION OF THE DRAWINGS

With reference to the appended drawings, below follows a more detailed description of aspects of the disclosure cited as examples.

FIG. 1A is a side view of an example of a vehicle comprising a fuel cell system in accordance with an example of the present disclosure.

FIG. 1B is a block diagram illustrating another example of a vehicle in accordance with an example of the present disclosure.

FIG. 2A is a block diagram illustrating a fuel cell system and one or more control systems in accordance with an example of the present disclosure.

FIG. 2B is a block diagram illustrating an example of a cooling system for cooling the fuel cell system, in accordance with an example of the present disclosure.

FIG. 3 is a flowchart illustrating an example of a method of operating a fuel cell system, in accordance with an example of the present disclosure.

FIG. 4A is another flowchart illustrating an example of a method of operating a fuel cell system, in accordance with an example of the present disclosure.

FIGS. 4B and 4C are flowcharts further illustrating an example of the method of operating the fuel cell system of FIG. 4A, in accordance with an example of the present disclosure.

FIGS. 5A and 5B are block diagrams illustrating an example of a control system for controlling operation of a fuel cell system, in accordance with an example of the present disclosure.

### DETAILED DESCRIPTION

Aspects set forth below represent the necessary information to enable those skilled in the art to practice the disclosure.

When a vehicle such as e.g. a fuel cell electric vehicle (FCEV) is stopped for a certain duration of time, e.g., parked, at a certain location, the fuel cell system of the vehicle may be shut down. Fuel cell systems included, for example, in FCEVs, are quite sensitive to cold temperatures and generally need to be prepared in anticipation of below-freezing conditions and/or to prepare for a freeze start-up that is a fuel cell system start-up at cold, such as freezing or below-freezing conditions. A fuel cell system may be prepared for current or possible future cold conditions by, for example, expelling water from inside a fuel cell stack of the fuel cell system, so as to prevent any water freezing in the fuel cell system which may cause severe, often irreparable damage. At the same time, a freeze preparation procedure, particularly if performed frequently, may cause damage and degradation to the fuel cell system.

If a freeze preparation procedure is performed without then shortly waking up the fuel cell system, there may still be some water undesirably left in the fuel cell system as all the water may not have condensed after hot operation of the fuel cell system. On the other hand, depending on a freeze preparation strategy, if a freeze preparation is performed at a later time, e.g., after waking up suitable components of the vehicle several hours or later after the fuel cell system shutdown, this can lead to an air-to-air start or even result in a fuel cell stack being at open circuit voltages for extended durations, which causes degradation of the fuel cell stack.

Thus, it is desirable to perform a freeze preparation of the fuel cell system less frequently and when ambient temperatures are below a certain level. If the conditions at the fuel cell system shutdown are not suitable for performing a freeze preparation, a control system of the vehicle may monitor the current conditions to check if they have changed and are suitable for performing the freeze preparation. This however requires the control system and other components of the vehicle, e.g., a controller of the fuel cell system, to be up and running to continuously monitor the current conditions and thereby determine if the conditions become appropriate to perform the freeze preparation. Such monitoring consumes energy of the vehicle during the vehicle stopover/parking.

If a freeze preparation procedure is performed without waking up the fuel cell system, there may still be some water undesirably left in the fuel cell system as all the water may not have condensed after hot operation of the fuel cell system. On the other hand, depending on a freeze preparation strategy, if a freeze preparation is performed at a later time, e.g., after waking up the vehicle several hours after the fuel cell system shutdown, this can lead to an air-to-air start or even result in a fuel cell stack being at open circuit voltages for extended durations, which causes degradation of the fuel cell stack. Thus, it is desirable to perform a freeze preparation less frequently and when ambient temperatures are dropping below a certain level. This however requires a controller of the fuel cell system to be up and running to continuously monitor the ambient temperature, and wake up or activate required components to perform the freeze preparation.

Furthermore, generally, a fuel cell system shutdown may not always be required. Also, even if the fuel cell system is shut down, it may be that the fuel cell system does not need to be subjected to a freeze preparation, and/or that the performance of the freeze preparation is not possible. The freeze preparation may not be an energy-efficient option given current circumstances.

Accordingly, the system and method herein allow, based at least on parameters such as a predicted and/or current ambient temperature and a duration of the vehicle stopover, determining whether a freeze preparation of the fuel cell system is required or not and, if it is required, performing the freeze preparation earlier at a time of shutting down the fuel cell system. In this way, certain functions of the one or more control systems of the vehicle do not need to be kept operational once the freeze preparation has been performed, thereby energy and thus costs of operating the fuel cell system and the vehicle are advantageously reduced.

Accordingly, the system and method herein allow, based at least on parameters such as an actual and predicted ambient temperature and a duration of the vehicle stopover, determining whether the freeze preparation of the vehicle's fuel cell system is required or not. If the freeze preparation is required and if it is not possible to wake up the fuel cell system during the stopover of the vehicle to then perform a freeze preparation, a forced freeze preparation is performed while shutting down the fuel cell system. The forced freeze preparation at a time of the shutdown of the fuel cell system is performed using, in addition to the primary cooling circuit or subsystem, an auxiliary cooling circuit or subsystem of the fuel cell system. The auxiliary cooling subsystem may be activated to be used in combination with the primary subcooling system, to assist the primary cooling subsystem to reduce the temperature of the fuel cell system to below a first threshold level, also referred to herein as a freeze preparation level, which may be lower than the ambient temperature. Thus, whereas the primary cooling subsystem may only be able to reduce the temperature of the fuel cell system to be as low as the ambient temperature, but not lower, the use of the auxiliary cooling subsystem allows further reducing the temperature of the fuel cell system to a temperature below the ambient temperature. In this way, the fuel cell system e.g. the stack may be cooled to a temperature that is required for performing the freeze preparation of the fuel cell system.

Also, the forced freeze preparation may be performed if the freeze preparation is required and if it is determined that the vehicle is expected to be occupied by a vehicle user, such as e.g. a driver of the vehicle, during at least part of the vehicle stopover. The driver may use the vehicle, e.g., a sleeper truck, for sleeping when the vehicle is parked, and in such cases it is advantageous to perform the freeze preparation in advance. The reasons for this include that, when freeze preparation is performed, an air compressor and other moving components of the fuel cell system and the vehicle may be operated. This can cause disturbance to the driver when the driver is sleeping. Thus, to avoid disturbing the driver, the fuel cell system may be force-cooled using one or both the primary cooling subsystem and the auxiliary cooling circuit, and the freeze preparation is then performed at the time of the shutdown of the fuel cell system, before the driver goes to sleep. This improves user expectations regarding the vehicle. Moreover, a proper rest of the driver improves safety of operation of the vehicle during driving.

The system and method herein may eliminate a need to keep certain functions of the control system of the vehicle activated, which results in advantages such as saving energy and reducing costs of operating the fuel cell system and the vehicle as a whole. In some cases, energy savings may be from a few hundreds of watt-hour (Wh) to a few kWh. Also, because the freeze preparation of the fuel cell system is performed responsive to determining that the freeze preparation is indeed required, a freeze preparation is performed less frequently, thereby a damaging impact on the fuel cell system is reduced.

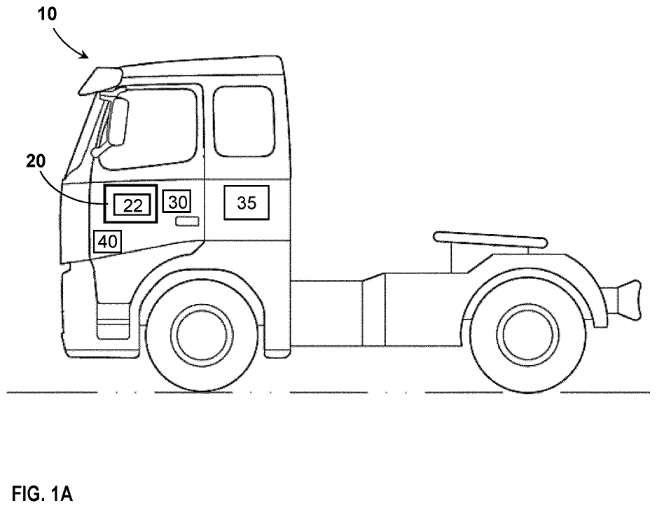

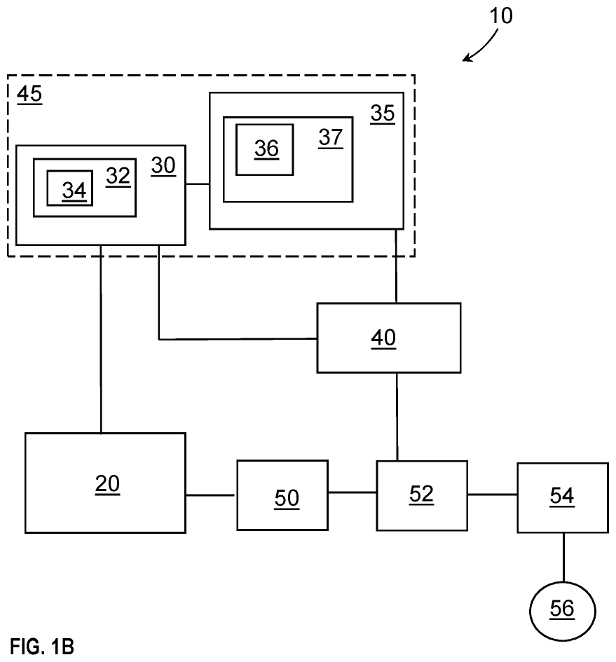

FIG. 1A is a side view of an example of a vehicle 10 in which some examples in accordance with the present disclosure may be implemented. The vehicle 10 is shown as a truck, such as a heavy-duty truck for towing one or more trailers (not shown). The vehicle 10 may be a fuel cell electric vehicle (FCEV) or a hybrid vehicle. It should however be appreciated that the present disclosure is not limited to this, or any other specific type of a fuel cell vehicle, and may be used in any other type of vehicle, such as a bus, a construction equipment vehicle, a passenger car, etc.

As shown schematically in FIG. 1A, the vehicle 10 comprises a fuel cell system 20 which may be used for powering one or more electric machines or motors (not shown) which are used for creating a propulsion force to the vehicle 10. The fuel cell system 20 may also be used for powering other electric power consumers (not shown) of the vehicle 10, such as an electric motor for a crane, an electric motor for a refrigerator system, an electric motor for a concrete mixing system, an electric motor for an air conditioning system, or any other electric power consuming function of the vehicle 10.

The vehicle 10 comprises a high voltage (HV) system including components such as a fuel cell system 20 comprising a fuel cell stack 22, a fuel cell controller or control system 30, an electrical storage system (ESS) 40, and various other components, such as a power inverter, electric machines, a charger, a DC-DC converter, an air conditioning compressor, an electric heating system, etc. As shown in FIG. 1A, the vehicle 10 comprises a vehicle controller or control system 35 configured to control operation of various components of the HV system of vehicle 10, including the fuel cell system 20. The vehicle control system 35 may perform functions of a power controller configured to control power electronics of the vehicle 10, and the vehicle control system 35 may control other functions in the vehicle. Some of the components of the HV system may have their own controllers or some components may share controllers, and the vehicle control system 35 is shown by way of example.

The fuel cell controller or control system 30 is configured to control operation of the fuel cell system 20. The vehicle control system 35 may be electrically coupled to the control system 30 such that the vehicle control system 35 and the fuel cell controller/control system 30 may communicate regarding operation of the fuel cell system 20 and other components of the vehicle. For example, the vehicle control system 35 may send control signals to the control system 30. A freeze preparation of the vehicle may require waking up some components of the HV system of the vehicle 10, as well as waking up the fuel cell system 20.

In some examples, the vehicle control system 35 may perform some or all functions of the control system 30. Thus, in some examples, the vehicle control system 35 may include processing circuitry configured to perform functions of the control system 30, such that the control system 30 is part of the vehicle control system 35. Furthermore, in some examples, some functions related to control of operation of the fuel cell system and its maintenance, including a freeze preparation, may be performed by either the control system 30 or the vehicle control system 35. Some functions can be interchanged between vehicle and fuel cell system controllers, such that some functions related to operation of the fuel cell system 20 can be performed by processing circuitry of the vehicle control system 35, and some functions related to operation of other components of the vehicle 10 can be performed by processing circuitry of the fuel cell control system 30.

The fuel cell system 20 comprises one or more, typically multiple, fuel cells which together form the fuel cell stack 22. The fuel cell stack 22 may comprise, e.g., multiple solid polymer electrolyte fuel cells that employs a polymer ion exchange membrane as an electrolyte membrane. The polymer ion exchange membrane is interposed between an anode and a cathode to form a membrane electrode assembly (MEA). The membrane electrode assembly and a pair of separators sandwiching the membrane electrode assembly form a fuel cell. A fuel cell has its components sandwiched between cathode and anode end plates. A number of the fuel cells, e.g. a hundred or more in a truck, are stacked together, and plates, such as the end plates and other plates, are assembled together to form a fuel cell stack. The fuel cell system 20 may include one or more fuel cell stacks. Also, the fuel cell system 20 may comprise one or more fuel cell systems, such that the vehicle 10 may have multiple fuel cell systems, e.g., two or more fuel cell systems. Thus, any reference to the fuel cell system 20 herein also applies to more than one fuel cell system.

As shown in FIG. 1A, the vehicle may comprise the electric energy storage (ESS) 40 such as e.g. one or more batteries, one or more supercapacitors, or a combination of one or more batteries and one or more supercapacitors. The ESS 40 is rechargeable and is adapted and configured to store electric energy, such as e.g. excess electric energy produced by the fuel cell system 20. The ESS 40 may store energy regenerated during braking such as regenerative braking, and/or it may be configured for charging by a charger, such as, e.g., from an external power grid. The ESS 40 is configured to assist the fuel cell system in supplying energy to the drive motor, to meet power/energy demands of the vehicle 10. The ESS 40 may be configured to provide additional propulsive power in situations when the complete required power cannot be provided by fuel cell system 20, or when it is not suitable to provide the complete required power by the fuel cell system 20. In various examples, the ESS 40 may provide electrical energy storage during regenerative braking, provide electrical energy storage device for electrical energy that is generated from a fuel cell system at low loads, assists the fuel cell system 20 with generating power at higher loads, or may serve as a main energy supplier in some circumstances.

The fuel cell system 20 and the ESS 40 can provide power to one or more auxiliary systems of the vehicle 10 such as other electric power consumers (not shown) of the vehicle 10, such as e.g. an electric motor for a crane, an electric motor for a refrigerator system, an electric motor for a concrete mixing system, an electric motor for an air conditioning system, or any other electric power consuming function of the vehicle 10. The vehicle 10 may be powered using electrical energy from any combination of the fuel cell system 20 and the ESS 40.

In some examples, the ESS 40 may be used to power the vehicle during the stopover of the vehicle. In some examples, the ESS 40 may be precharged in anticipation of the stopover of the vehicle.

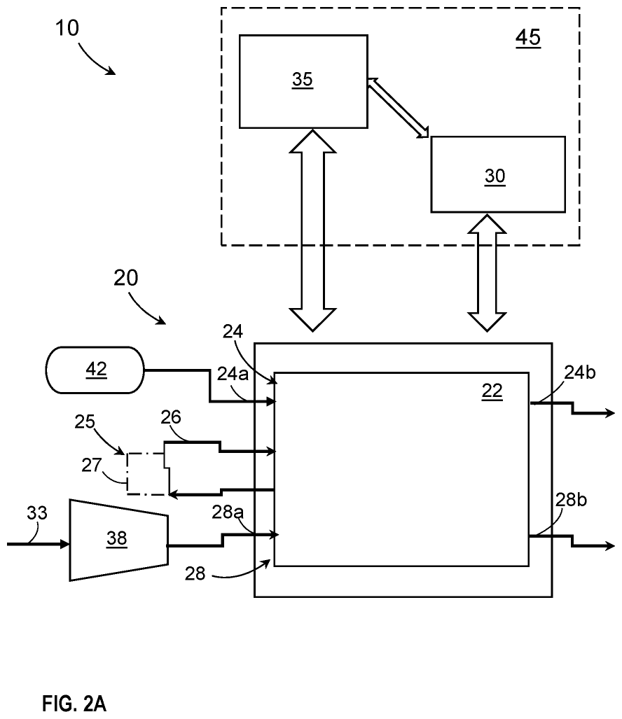

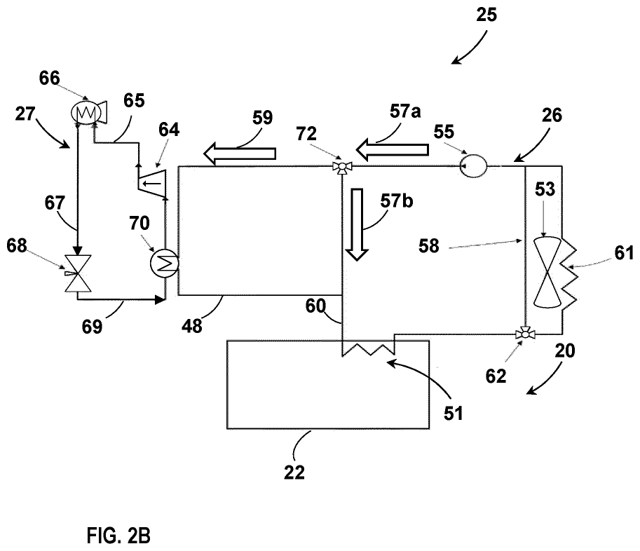

The fuel cell system 20 is configured to provide the fuel cells with necessary supply of hydrogen fuel (H₂) and oxidizer such as air or oxygen, as well as with cooling, humidification, etc. The fuel cell system 20 may include various components, some of which are shown in FIGS. 1B, 2A and 2B, discussed below.

The fuel cell system 20 may comprise multiple fuel cell systems, and each fuel cell system may comprise its own control system, which may be communicatively connected to a controller or control system. The fuel cell system 20 may comprise a single fuel cell system, two fuel cell systems, or more than two fuel cell systems, such as three or more fuel cell systems.

The fuel cell system controller or control system 30 comprises one or more units, according to an example of the present disclosure. The control system 30 is configured to control operation of the fuel cell system 20, e.g. of an anode, a cathode, and other components and subsystems such as e.g. primary and auxiliary cooling subsystems, as discussed in more detail below. The fuel cell system 20 may be communicatively coupled to the control system 30. In the example of FIG. 1A, the fuel cell system 20 is shown to include the control system 30 but the control system 30 may be a component that is separate from the fuel cell system 20 and that is communicatively coupled to the fuel cell system 20. In some examples, the control system 30 may be part of the vehicle control system 35.

In implementations (not shown) in which the fuel cell system 20 comprises multiple fuel cell systems, each fuel cell system may comprise its own control system. In some implementations, a control system may control operation of multiple control systems.

The control system 30 may be configured to control the fuel cell system 20 by issuing control signals and by receiving status information relating to the fuel cell system 20 and its components. The control system 30 may be configured to receive information from various sensors, including one or more of temperature sensors, pressure sensors, moisture sensors, and other sensors included in or associated with the fuel cell system 20 and/or the vehicle 10. For example, an ambient temperature sensor may be positioned such that it can measure an ambient temperature, such as a temperature outside and/or in the vicinity of the vehicle, that reflects a temperature to which the fuel cell system 20 is subjected. Various sensors may acquire measurements regarding internal operation of the fuel cell system 20. Thus, a temperature sensor for monitoring a temperature of the fuel cell stack of the fuel cell system 20 may be positioned in the stack or in the vicinity in the stack, i.e. in a location at which a measured temperature at which reflects the temperature of the fuel cell stack. As another example, a moisture or humidity sensor may be included in the fuel cell system 20 to monitor humidity levels of a membrane, such as e.g. a proton-exchange membrane (PEM), of the fuel cell stack.

The control system 30 may be communicatively coupled to an internal database, an external database, or a combination of internal and external databases, to receive historical data on the vehicle operation; historical data related to driver's driving pattern and a pattern of operation of the vehicle; historical data on frequency, locations, and durations of stops along routes traveled by the vehicle in the past; historical data on ambient conditions at the locations traveled by the vehicle; historical data on missions or tasks performed by the vehicle, including a schedule of the tasks and related routes, etc.

The control system 30 may communicate with various external data providers, e.g., weather services or servers, Global Positioning System (GPS) servers, Global Navigation Satellite System (GNSS) servers, map servers, and/or any other servers and/or services from which information useful for methods herein may be obtained. The control system 30 may receive data from a weather service which may include data on actual and predicted weather conditions, and other types of data. The data on weather conditions, such as actual and/or predicted weather conditions, may include data on as a temperature e.g. at a vehicle's current location, altitude, humidity, and wind speeds. Also, the control system 30 may be aware of specifics of a location in which the vehicle is stopped, such as e.g. whether the vehicle is parked indoors or outdoors, typical e.g. historic ambient temperatures and their variation at that geographical location, a typical time of a vehicle stop at that location, etc.

The control system 30 may be an electronic control unit and may comprise processing circuitry which is adapted to execute a computer program code or computer-executable instructions to perform a method in accordance with some examples. The control system 30 may comprise hardware, firmware, and/or software for performing methods according to examples of the present disclosure. The control system 30 may be denoted a computer. The control system 30 may be constituted by one or more separate sub-control units. In addition, the control system 30 may communicate by use of wired and/or wireless communication technology.

FIG. 1B further illustrates an example of some components of the HV system of the vehicle 10 in accordance with an example of the present disclosure. The vehicle 10 comprises the fuel cell stack 22 of the fuel cell system 20, the ESS 40 such as e.g. one or more batteries and/or one or more supercapacitors, a DC/DC converter 50, a junction box or unit 52, an electric motor or electric machine 54, and wheels 56. The vehicle 10 also comprises the fuel cell system controller/control system 30 and the vehicle controller 35. In some examples, the fuel cell system controller 30 and the vehicle controller 35 may be part of the same control system 45 as shown by a dashed line in FIG. 1B.

Electric power generated by the fuel cell stack 22 is supplied to the junction box or unit 52, such as e.g. a high-voltage junction box, through the DC/DC converter 50 that converts and stabilizes the voltage. The power is supplied, via the junction unit 52, to the electric machine 54 for providing propulsion power to the wheels 56 of the vehicle 10. The junction unit 52 is a component that serves as a meeting spot for electrical connections between the fuel cell stack 22, the ESS 40, and the electric machine 54. Traction power to the wheels 56 is delivered by the electric machine 54 supplied by one or both the fuel cell stack 22 and the ESS 40. The vehicle 10 may comprise other components such as e.g. inverters, various other controllers, etc.

As shown in FIG. 1B, the fuel cell system controller/control system 30 may comprise a processing circuitry 32 comprising a monitoring unit 34 that is configured to acquire sensor and other measurements and performs other processing related to operation of the fuel cell system. The monitoring unit 34, which may encompass more than one units, may be controlled to be in one of an activated mode, a deactivated mode, or a partially activated/deactivated mode. In the activated mode, the monitoring unit 34 is operated to acquire and process sensor measurements, and can activate the fuel cell system 20 to perform a freeze preparation. In some cases, the monitoring unit 34 may be configured to selectively operate in more than one mode, e.g., it can also be operated in a partially activated/deactivated mode in which some of its functions are activated and some are deactivated. When the monitoring unit 34 is operating during a stopover of the vehicle, the unit 34 monitors a status or conditions at the fuel cell system 20 to determine whether to wake-up the fuel cell system 20, to perform a freeze preparation. In the deactivated mode, or in a partially activated mode, of the monitoring unit 34, e.g., during a stopover of the vehicle 10 when no monitoring of the fuel cell system 20 is required or only partial monitoring of the fuel cell system 20 is performed, energy costs may be saved. In some examples, it is advantageously determined whether the monitoring unit 34 needs to be in the activated mode or whether it can be switched to the deactivated mode or partially activated mode to thereby increase energy savings.

As also shown in FIG. 1B, the vehicle control system 35, configured to control operation of various components of the vehicle 10, comprises processing circuitry 37 such as one or more processors. The processing circuitry 37 may comprise a monitoring unit 36 that is configured to acquire sensor and other measurements and to perform other processing related to operation of the vehicle 10. The monitoring unit 36 of the vehicle control system 35 may be controlled to operate in one of an activated mode, a deactivated mode, or in a partially activated/deactivated mode in which some of its functions are activated and some are deactivated. In some cases, certain functions of the monitoring unit 36 are always turned on during a lifetime of the vehicle 10. Depending on the configuration and operating mode of the monitoring unit 36, the processing circuitry 37 of the vehicle control system 35 may control components of the vehicle 10 to be turned on or off, or to be idling, including during the stopover/parking of the vehicle. The monitoring unit 36 is configured to, during the stopover of the vehicle 10, monitor various components of the vehicle 10 and to control one or more components to be deactivated or woken up during the stopover, e.g., to perform a freeze preparation of the fuel cell system 20. In the deactivated mode or in the partially activated/deactivated mode of the monitoring unit 36, energy costs may be saved. Furthermore, because at least some of the components of the vehicle 10 and the fuel cell system 20 are not operating during the vehicle stopover, these leads to energy savings. For example, temperature and other sensors may not be operating when the fuel cell system 20 is shut down and no monitoring of surrounding conditions is performed because the freeze preparation of the fuel cell system 20 has already been performed.

The fuel cell system controller 30 and the vehicle control system 35 may comprise other units for controlling, by processing circuitry, operation of the fuel cell system 20 and other components of the vehicle 10.

In some examples, as shown in FIG. 1B, the fuel cell system controller 30 and the vehicle controller 35 may be part of the same control system 45. The control system 45, which may be a main vehicle controller, may comprise processing circuitry (not shown) that is configured to perform some or all of the functions of the processing circuitry 32 of the fuel cell system controller/control system 30 and/or of the processing circuitry 37 of the vehicle control system 35. The control system 45 may comprise various units, including a monitoring unit (not shown) similar to the monitoring unit 34 of the fuel cell system controller/control system 30 and the monitoring unit 36 of the vehicle control system 35.

In some examples, after the freeze preparation of the fuel cell system 20 is performed, some of the functions of the control system 45, e.g., the function related to monitoring a state of the fuel cell system 20, are deactivated such that energy may be saved during the vehicle parking. Furthermore, some of the function of the vehicle 10 itself, e.g. of its components, may be deactivated which thereby also contributes to energy saving.

FIGS. 2A and 2B illustrate an example of components of the vehicle 10, including the fuel cell system 20 in which methods in accordance with aspects of the present disclosure may be implemented. As depicted in FIG. 2A, the vehicle 10 comprises the fuel cell system 20 comprising the fuel cell stack 22 comprising multiple fuel cells (not shown). Operation of the fuel cell system 20 is controlled by one or more control devices or systems, such as one or more out of the fuel cell controller/control system 30, the vehicle control system 35, and the control system 45. The control system 45, which may be referred to as a main control system of the vehicle 10, may be configured to perform functions of the fuel cell controller 30 and the vehicle control system 35. In some examples, the control system 45 may be a vehicle controller.

In the fuel cell stack 22, an electrolyte, such as e.g. a polymer electrolyte membrane (PEM) (not shown), is sandwiched between two electrodes or catalyst layers-an anode or anode side 24 and a cathode or cathode side 28. The vehicle 10, e.g., the fuel cell system 20, also includes a cooling system 25 comprising a primary cooling subsystem 26 and a secondary or auxiliary cooling subsystem 27, as schematically shown in FIG. 2A and illustrated further in FIG. 2B. It should be noted that the anode side 24, the cooling system 25, and the cathode side 28 are shown schematically, without indicating their boundaries or details of their configuration. A person of skill in the art would understand how to implement a fuel cell stack.

As shown in FIG. 2A, the anode side 24 comprises an anode inlet 24a and an anode outlet 24b, and the cathode side 28 comprises a cathode inlet 28a and a cathode outlet 28. It should be noted that the respective inlets and outlets are shown by way of example only. In some examples, fuel and oxidant inlets and outlets are provided in one end plate of the fuel cell stack 22. In some examples, fuel and oxidant outlets are provided in both end plates of the fuel cell stack 22. It should be understood that the fuel cell stack 22 can have any suitable arrangement of cathode and anode inlets and outlets.

As shown by an arrow 33 in FIG. 2A, air from the outside environment, e.g. an ambient air, is supplied to an air compressor 38 that pressurizes the air, thereby a compressed air is created and supplied from the air compressor 38 to the cathode 28 via the cathode inlet 28a. The air may also be filtered before entering the air compressor 38. Also, before being supplied to the cathode 28, the air may be cooled and humidified.

In the example shown in FIG. 2A, the fuel cell system 20 is shown to comprise a fuel storage device 42 such as one or more hydrogen storage containers or tanks fluidly connected to the anode 24 such that hydrogen is supplied to the anode 24. The fuel storage device 42 may have any suitable configuration. In some embodiments, the fuel cell system 20 may alternatively or additionally receive hydrogen fuel from a source device configured to generate hydrogen.

A cathode output flow of the cathode 28 passes through the cathode outlet 28b, possibly through other components, to the outside i.e. atmosphere. In some cases, the output flow comprising byproducts of the electrochemical reaction in the fuel cell stack 22 that generates electrical energy (not illustrated) is reused at least in part in the fuel cell system 20 and/or in the vehicle 10. As shown in FIG. 2A by way of example, an anode output flow of the anode 24 exits the fuel cell stack 22 through the anode outlet 24b and can also be expelled to the outside of the fuel cell system 20. In some examples, the anode output flow may be combined with the cathode output flow such that their combined contents or an exhaust flow are expelled to the outside, and/or reused in part. The exhaust flow mainly includes water and hot or warm air, and may include certain amounts of hydrogen.

The primary cooling subsystem 26 is configured to control a temperature of the fuel cell system 20, i.e. the fuel cell stack 22. The primary cooling subsystem 26 may have any suitable configuration that allows a coolant, e.g. water and/or other medium, to be circulated to control the temperature of the fuel cell system 20, e.g. the fuel cell stack 22 and other components of the fuel cell system 20. In examples herein, the primary cooling subsystem 26 is configured and adapted to reduce the temperature of the fuel cell system 20 to a minimum temperature that is equal to or approximately equal to an ambient temperature. Thus, the primary cooling subsystem 26 is configured to only be able to reduce the temperature of the fuel cell system 20 to as low as the ambient temperature.

Furthermore, in examples herein, as shown schematically in FIG. 2A, the auxiliary cooling subsystem 27 is provided that is configured to assist the primary cooling subsystem 26 in controlling the temperature of the fuel cell system 20. The auxiliary cooling subsystem 27 may be configured to be controlled to facilitate cooling of the fuel cell system 20, such that the temperature of the fuel cell system 20 may be reduced to below the ambient temperature. In some examples, based e.g. on the ambient temperature, the auxiliary cooling subsystem 27 may assist the primary cooling subsystem 26 to bring the temperature of the fuel cell system 20 to below a freeze preparation level which is a temperature threshold, referred to herein as a first threshold level, below which a freeze preparation of the fuel cell system 20 may be performed. It should be noted that, in FIG. 2A, the location of the auxiliary cooling subsystem 27 is shown schematically relative to the primary cooling subsystem 26, only to illustrate that the system described herein comprises the auxiliary cooling subsystem 27 in addition to the primary cooling subsystem 26.

FIG. 2B illustrates an example of a cooling system 25 of the fuel cell vehicle 10 comprising the primary cooling subsystem 26 and the auxiliary cooling subsystem 27. In examples herein, the primary cooling subsystem 26 is configured to control a temperature of the fuel cell stack 22 during operation and to cool down the fuel cell stack 22 when the fuel cell system 20 is shut down. The primary cooling subsystem 26 may be implemented as a coolant circulating circuit in the form of a loop 60 comprising a conduit, or a series of conduits, in which a coolant pump 55 circulates a suitable coolant. The pump 55 comprises or is coupled to an electric motor (not shown) which is controlled to thereby control the flow of the coolant through the coolant circulating circuit 60. For example, a controller, such as the control system 30 may be configured to control the operation of the coolant pump 55, as well as other components of the primary cooling subsystem 26 of the fuel cell system 20. The control system 30 may be configured to control activation and deactivation of the components of the primary cooling subsystem 26. A direction of circulation of the coolant in the primary cooling subsystem 26 is shown by arrows 57a, 57b, by way of example. The coolant circulating circuit 60 may exchange heat with the fuel cell stack 22, as shown schematically by a heat exchanger 51 in FIG. 2B. The temperature of the fuel cell stack 22, and of the entire fuel cell system 20, can thereby be reduced as the coolant circulating circuit 60 is operating to cool down the fuel cell stack 22.

The coolant circulating circuit 60 comprises a heat exchanger 61 such as e.g. a radiator of the vehicle 10 that allows an air-to-liquid heat exchange for cooling the coolant flown in the circuit 60. Thus, as the heat exchanger 61 has the coolant passing therethrough, with assistance of a flow distribution device such as e.g. a fan 53, the temperature of the coolant can be reduced due to heat exchange with a colder outside/ambient temperature. In this way, the coolant circulating circuit 60 can operate to cool the temperature of the coolant due to an exchange with the ambient air in the outside environment.

Furthermore, as shown in FIG. 2B, in some examples, the coolant circulating circuit 60 comprises a bypass path or conduit 58 to which the coolant can be diverted as part of the coolant temperature control. For example, during a start-up of the vehicle, it may be required to increase a temperature of the coolant, and, in such cases, a first valve 62 can be operated to move to a position in which the coolant is directed through the bypass path 58 rather than towards the heat exchanger 61. The first valve 62 is a three-way valve proportional in this example, and it is configured to control the flow of the coolant so that the coolant enters the bypass conduit 58. The bypass conduit 58 may include components, e.g. a heater, not shown in FIG. 2B, that allow increasing the temperature of the coolant. Also, the primary cooling subsystem 26 may have various other additional components, as the specific configuration is shown in FIG. 2B by way of example only.

In examples herein, as shown in FIG. 2B, the cooling system 25 comprises, in addition to the primary cooling subsystem 26, the auxiliary cooling subsystem 27 which is adapted and configured to assist the primary cooling subsystem 26 in cooling the fuel cell system 20. As shown in FIG. 2B, the primary cooling subsystem 26 may comprise a second valve 72 which is controlled to allow the coolant circulating in the primary cooling subsystem 26 to flow through a cooling bypath conduit 48 of the cooling system 25, in the direction shown by an arrow 59, to be further cooled in the auxiliary cooling subsystem 27. In some examples, in response to detecting a need to activate an auxiliary cooling system, e.g., to reduce a temperature of the fuel cell system to be below an ambient temperature, the second valve 72 can be controlled to allow the coolant to flow through the cooling bypath conduit 48 to be further cooled by the auxiliary cooling subsystem 27. The second valve 72 may be, e.g. a three-way proportional valve.

A configuration of the auxiliary cooling subsystem 27 is shown in FIG. 2B by way of example. As shown, the auxiliary cooling subsystem 27, such as e.g. a refrigeration circuit, may be a closed-loop system comprising a compressor 64, a condenser 66, an expansion device 68, and an evaporator 70 that are fluidly coupled via piping. The evaporator 70 comprises a heat exchanger. In some examples, the expansion device 68 and the evaporator 70 may be incorporated in the same evaporator unit.

In the closed-loop system of the auxiliary cooling subsystem 27, a refrigerant enters the compressor 64 that outputs compressed refrigerant, as shown by arrow 65, which is supplied to the condenser 66. The condenser 66 is configured to cool the compressed refrigerant and to condense the refrigerant to a saturated liquid. Thermal energy is transferred from the refrigerant to the ambient environment in the condenser 66.

The refrigerant flows from the condenser 66 to the expansion device 68 (arrow 67). The pressure and the temperature of the refrigerant are reduced as the refrigerant passes through the expansion device 68. The lower-pressure, lower-temperature refrigerant then flows to the evaporator 70 via the piping (arrow 69). The coolant of the primary cooling subsystem 26, that is to be (further) cooled using the auxiliary cooling subsystem 27, is circulated into and out of the evaporator 70 via piping of the cooling bypath conduit 48. The refrigerant absorbs thermal energy from the coolant, which may be a suitable heat-transfer medium, thereby chilling or cooling the coolant and providing the desired refrigerating effect.

The auxiliary cooling subsystem 27 may be activated, e.g. by the control system 30, to be used in conjunction with the primary cooling subsystem 26, to reduce the temperature of the coolant and thereby reduce the temperature of the fuel cell system 20, comprising the fuel cell stack 22 and other components, to below the ambient temperature.

The auxiliary cooling subsystem 27 may comprise any other components that are not shown herein. For example, one or more buffer tanks and hydrogen cooling may be used to cool the fuel cell system as described, e.g., in International Application PCT/EP2021/050069 published as WO2022148526. Also, the auxiliary cooling subsystem 27 may have other configurations, as examples herein are not limited to a specific configuration of the auxiliary cooling subsystem.

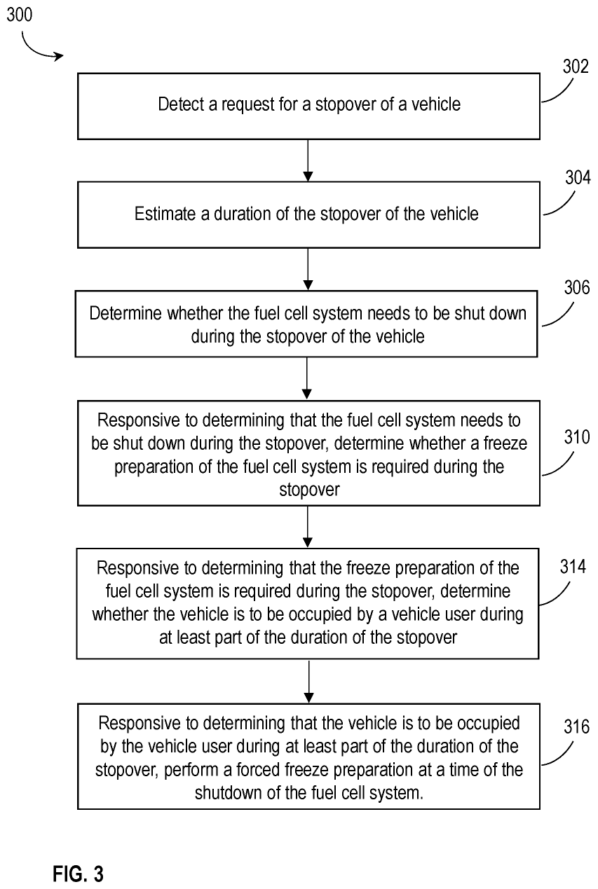

FIG. 3 illustrates an example of a method or process 300 of controlling operation of a fuel cell system of a fuel cell vehicle such as the vehicle 10 shown in FIGS. 1A and 1B. The method or process 300 may be a computer-implemented method performed by processing circuitry of a control device or system such as e.g. the control system 30, the vehicle controller 35, or the main controller 45 shown in FIGS. 1A, 1B, and 2A.

The process 300 may begin, e.g., at block 302, when a request for a stopover of the vehicle is detected. The request or instruction to stop and park the vehicle may be received or detected, e.g., when vehicle is stopped and an indication is received that the vehicle is parked. For example, parking brakes such as e.g. electronic parking brakes may be activated or enabled. In some examples, the vehicle may be keyed off, e.g. the driver of the vehicle moves or otherwise causes a vehicle key device to an off position, to power down the vehicle. A stop or stopover of the vehicle is considered to begin at the point in time when the request for the stopover and/or parking of the vehicle is detected. As used herein, the vehicle stopover is equivalent to the parking of the vehicle. A traction electric machine of the vehicle, such as electric machine 64, is not operating during the vehicle stopover/parking. One or more of other electric components of the vehicle 10 may be operational. It should be noted that, when the vehicle is stopped/parked, the fuel cell system can either be running or shut down. For example, even in cases when the driver is not in a vehicle cabin and the vehicle is parked for e.g. days, the fuel cell system and/or other components and subsystems in the vehicle may be operating or woken up to perform certain functions, e.g., to ensure that batteries are not discharged.

It should be noted that, in some cases, some electric machines of the vehicle, such as a fuel cell electric vehicle (FCEV), may not be shut off and may continue operating during the stopover of the vehicle. In some cases, one or more auxiliary power take-off devices may require power during the stopover of the vehicle. For example, a concrete mixer vehicle, even if parked, will need power for uninterrupted operation of concrete mixing. Various other systems, such as a refrigerator, air conditioning, heating, etc. may continue their operation during the vehicle stopover. Also, the vehicle may be used by a driver, and/or another person, and such person(s) may be sleeping or be in general present in the vehicle. In such cases, certain auxiliary devices of the vehicle may need to be turned on, continuously or at certain points during the stopover, e.g. an air conditioning system, a heater, an entertainment system, a lighting system, a wireless communication system, etc.

When the vehicle 10 is parked, the fuel cell system 20 may continue operating for a certain duration of time, or in some examples during the entire stopover of the vehicle 10. A shutdown and start-up or restart of the fuel cell system 20 may be controlled independently of a control of the vehicle 10, even though the operation of the fuel cell system depends on a load which decreases greatly when the vehicle stops moving. The vehicle may receive power during the stopover from an electric energy storage (ESS) such as ESS 40, and/or from a combination of the fuel cell system 20 and the ESS 40.

The request for a vehicle stopover/parking may be an actual stopover or a predicted stopover. The actual stopover may be detected e.g. based on receiving a driver input instructing the vehicle to stop. In some circumstances, the vehicle may be expected to stop at a certain location and/or at a certain time, e.g. for a driver's scheduled rest or for another reason, and the request for a stopover may be generated automatically, based on one or more out of a current location of the vehicle, a current time, and other factors. For example, when weather conditions are expected to be not suitable for driving for a certain duration of time at a certain location, the control system may predict a stopover of the vehicle.

At block 304, the process 300 comprises estimating or determining a duration of a stopover of the vehicle when the request for the stopover of the vehicle is detected. The duration of the stopover, i.e. for how long the vehicle is expected to remain in a stop or parking mode before it is next started, may be determined or estimated based on one or more out of a current location of the vehicle, historical data related to operation of the vehicle, historical data on driver behaviour, historical data on other events, current and predicted ambient conditions, a time of the day, driver input, and other type of data.

The historical data related to operation of the vehicle and historical data on driver behaviour such as e.g. a pattern of a driver behaviour may indicate that the vehicle is used for a certain mission at certain times of the day, while at other times, e.g., at night, the vehicle is parked. In some examples, from the history of operating the vehicle, it may be known that given one or more out of a certain location, a time of the day, a day of the week, a calendar date, weather conditions, etc., the vehicle is stopped for a certain duration of time. For example, it may be known that, at the current location, the vehicle is typically parked for a certain amount of time. It may be known, for example, that the vehicle is typically parked overnight at the current location.

As another example, it may be known that the driver has a scheduled break or rest at a certain location for a certain duration of time. Also, depending on a type of the vehicle, e.g., a taxi, a public transportation vehicle, a long haul vehicle, etc., the vehicle may experience different start-stop patterns that may be predicted based on previous use of the vehicle and previously logged data. In some cases, the vehicle may be a sleeper truck or tractor, e.g., a long-haul truck.

As another factor, in some cases, driver shifts and laws stating how long drivers can be on the road and/or for how long they are required to take breaks may be taken into consideration in determining a time and duration of a vehicle stopover, which may be different for different vehicle types. For example, in some cases, the driver may be instructed to make a stop for a certain duration of time, e.g., for a mandatory break. An instruction may be communicated to the driver via the vehicle dashboard or console, or via another device through which the driver is communicating, e.g., with a fleet operator if the vehicle is part of the fleet of vehicles. The driver may then provide an input to the vehicle explicitly indicating for how long the vehicle will be stopped, which is communicated to the control system, such as one or more out of the control system 30, vehicle control system 35, and the main controller 45.

In some examples, an explicit input on a duration of the vehicle stopover may be received from the driver via an input device of the vehicle or a device capable of communicating with the vehicle, the input indicating for how long the vehicle stopover is expected. The input device may be, e.g., provided by a display device that can receive input, such as, e.g., a touch input, keyboard input, voice input, input from various other input devices, etc., from a user such as the driver. The display device may be located, e.g., on a dashboard or center console. In some embodiments, the display device may be a display of a mobile device of a user such as the driver, and driver input received via such display device may be received remotely, while the driver is not necessarily in proximity to the vehicle. For example, an application or app executing on a driver's mobile device may be configured to receive driver's input regarding the length of the stopover. Any other type of device may be used to receive an input from a driver, or other person, regarding a duration of the vehicle stopover.

The duration of the vehicle stopover may be determined in various other ways. The duration of the stopover of the vehicle may be in the form of a time until the next (re)start of the vehicle i.e. an actual duration of the stopover, or in the form of a time of the next (re)start of the vehicle.

At block 306, it is determined whether the fuel cell system needs to be shut down during the stopover. As used herein, a fuel cell system may need to be shut down when it is more beneficial for the operation of the fuel cell system and the entire vehicle, for cost, safety, and other reasons, that the fuel cell system is shut down for the duration of the stopover of the vehicle. It should be appreciated that the “need” to shut down the fuel cell system does not indicate that it is impossible to keep the fuel cell system operational, but indicates that an automatic decision is made to shut down the fuel cell system. The fuel cell system is shut down when a fuel cell stack of the fuel cell system is instructed to stop generating electricity.

The determining of whether the fuel cell system needs to be shut down during the stopover is based at least on the duration of the stopover of the vehicle. The fuel cell system may need to be shut down in response to various factors, including one or more of the duration of the stopover, an ambient temperature at the stopover location, a status of the fuel cell system of the vehicle, and other factors. The ambient temperature may be an actual i.e. current ambient temperature and/or a predicted ambient temperature.

In some examples, if the stopover of the vehicle is expected to be longer than a certain threshold duration, the fuel cell system may need to be shut down. As another example, if the ambient temperature during the stopover is expected to be below a certain threshold temperature, the fuel cell system may be kept operational to prevent it from freezing or from a damage that may be caused by a subsequent freeze start-up. At the same time, depending on the length of the stopover period, the fuel cell system may still be shut down and freeze start-up preparation may be performed if needed-simultaneously with the fuel cell system shutdown or after the fuel cell system shutdown. Various other approaches may be used additionally or alternatively.

When the fuel cell system is shut down during the stopover of the vehicle, certain electrical devices in the vehicle or associated with the vehicle may be operating. For example, an air conditioning system, a heating system for heating a cabin, etc. may be operating. These auxiliary devices may be powered by energy stored in the electrical storage system such as e.g. ESS 40 (FIGS. 1A and 1C).

At block 310, the control system 30, responsive to determining that the fuel cell system needs to be shut down during the stopover of the vehicle, determines whether a freeze preparation of the fuel cell system is required during the stopover of the vehicle. This processing involves determining, when a decision has been made to shut down the fuel cell system, whether the fuel cell system is required to be subjected to freeze preparation procedures which may be any suitable type of freeze preparation.

In some examples, the determining of whether the freeze preparation of the fuel cell system is required during the stopover of the vehicle is based on a predicted and/or current ambient temperature and/or a thermal model of the fuel cell system. The determining may be performed using the thermal model of the fuel cell system in combination with an estimation of a heat loss to the surrounding environment, which is a function of an ambient temperature. The ambient temperature may be an actual ambient temperature and/or a predicted ambient temperature. Any other suitable thermal model may be used, as methods described herein are not limited to any specific thermal model. In some examples, the thermal model may be, for example, a validated, one-dimensional or multi-dimensional thermal model generated to calculate individual fuel cell temperatures. A need for a freeze preparation may be evaluated by determined end-cell temperatures within the fuel cell stack, i.e., the temperatures of individual fuel cells at the endplates of the fuel cell stack, which may reach freezing temperatures sooner than other fuel cells within the fuel cell system. In some examples, the thermal model may comprise a lumped stack model that is used to determine a mass-average fuel cell stack temperature to evaluate a need for freeze protection.

The thermal model used may, for example, operate based on an ambient temperature input from a weather prediction service, a measured ambient temperature input taken from a temperature sensor external to the fuel cell system, or a measured temperature input taken from a temperature sensor internal to the fuel cell system, e.g., one more sensors within a coolant subsystem. In some cases, the thermal model may be generated as described in, e.g., Henao, N., et al. (“PEMFC low temperature startup for electric vehicle,” IECON 2012-38th Annual Conference on IEEE Industrial Electronics Society, 2012, pp. 2977-2982), Amamou, A., et al. (“Thermal Management Strategies for Cold Start of Automotive PEMFC,” 2015 IEEE Vehicle Power and Propulsion Conference (VPPC), 2015, pp. 1-6), and Khandelwal, M., et al. (“One-dimensional thermal model of cold-start in a polymer electrolyte fuel cell stack,” Journal of Power Sources, 2007, vol. 172, pp. 816-830). Any other suitable thermal model of the fuel cell system may be used additionally or alternatively.

Regardless of the type of the thermal model, or a combination of thermal models, a thermal performance of the fuel cell stack (including when the fuel cell system is shut down) may be modeled, in dependence on the ambient temperature.

In some examples, whether the freeze preparation of the fuel cell system is required during the vehicle stopover is determined based on an ambient temperature, such as a current ambient temperature and/or predicted ambient temperature. For example, the freeze preparation may be determined to be required given one or more of the following events or conditions: the ambient temperature is predicted to fall below a certain threshold temperature at one or more time points during the vehicle stopover, the ambient temperature is predicted to fall below the certain threshold temperature for a certain duration of time during the vehicle stopover, the ambient temperature is predicted to fall below the certain threshold temperature for a duration of time during the vehicle stopover which duration of time is longer than a threshold duration of time, a current ambient temperature is below the certain threshold temperature, etc. The certain threshold temperature may selected from, e.g., one or more out of 10° C., 5° C., 0° C., −5° C., −10° C., and −15° C. In some examples, any other threshold temperature may be used.

At block 314, responsive to determining that the freeze preparation of the fuel cell system is required during the stopover of the vehicle, the control system 30 determines whether the vehicle is expected to be occupied by a vehicle user during at least part of the duration of the stopover of the vehicle. In some examples, the vehicle user is a driver of the vehicle. The driver may occupy the vehicle when the vehicle is parked at a certain location. In some examples, the vehicle is expected to be occupied by the driver means that the driver is expected to be sleeping in the vehicle while the vehicle is stopped. For example, long-haul vehicles i.e. sleeper cabs are equipped to allow the driver to sleep or rest in the vehicle. The vehicle may be a heavy-duty vehicle, e.g., performing a mission, and a driver of that vehicle may be sleeping in the vehicle during stops and/or overnight. In should be appreciated that sleeping may include resting or other status during a stopover of the vehicle. In addition, in some examples, the interior of the vehicle e.g. a sleeper cabin may be equipped with sensors, such as e.g. a motion sensor, a video camera, an infrared sensor, a biometric sensor, etc., that may monitor a driver status, such that it may be determined when the driver is actually asleep. The control system 30 may use historical data on driver sleep patterns during vehicle stops, to predict for any given vehicle stopover whether the driver is expected to sleep during that stopover. In some cases, input from a driver may be received that indicates that the driver is going to sleep in the vehicle during the stopover.

In examples herein, when the vehicle is expected to be occupied by the driver during at least part of the duration of the stopover of the vehicle, a freeze preparation may be performed in advance, at a time of the shutdown of the fuel cell system. Typically, when a freeze preparation is performed, a compressor such as air compressor 38 (FIG. 2A), and other components in the fuel cell system that have moving parts, may be operated. This may cause disturbance to the driver when the driver is sleeping, thereby compromising driver's ability to get adequate rest, during the stopover/parking of the vehicle, which may affect safety of subsequent operation of the vehicle. In order to avoid such situations, an early freeze preparation, also referred to herein as a forced freeze preparation, may be performed at the time of the shutdown of the fuel cell system and before the driver is going to, and/or expected to, sleep in the vehicle.

As mentioned above, the vehicle user may be a person other than the driver of the vehicle.

At block 316, responsive to determining that the vehicle is expected to be occupied by the vehicle user during at least part of the duration of the stopover, the control system 30 performs the forced freeze preparation, i.e. controls the fuel cell system to perform the forced freeze preparation at the time of the shutdown of the fuel cell system. The freeze preparation of the fuel cell system is referred to herein as a forced freeze preparation to indicate that a temperature of the fuel cell system is actively caused to be reduced so that the fuel cell system is in a condition for performing a freeze preparation. The forced freeze preparation of the fuel cell system at the time of the shutdown of the fuel cell system may comprise performing a shutdown of the fuel cell system, i.e. instructing the fuel cell system to shut down; reducing the temperature of the fuel cell system below a first threshold level using one or both the primary cooling subsystem and the auxiliary cooling subsystem of the cooling system; and performing the freeze preparation of the fuel cell system. The forced freeze preparation at the time of the shutdown of the fuel cell system may also comprise activating an auxiliary cooling subsystem of the cooling system of the fuel cell vehicle. The freeze preparation is performed after the fuel cell system has been shut down and its temperature has been reduced below the first threshold level. The first threshold level may be e.g. one of 10° C., 5° C., 0° C., −5° C., and −10° C. In some examples, the first threshold level is close to 0 ° C., e.g., 1° C., or 2° C., or 3° C., or 4° C., or 5° C. It may be advantageous to perform a freeze preparation before the water in the fuel cell system actually freezes. In some examples, the first threshold level may be at a freezing level. As discussed above in connection with FIG. 2B, the auxiliary cooling subsystem may be activated to assist the primary cooling subsystem in cooling the fuel cell system below the first threshold level that can be lower than the ambient temperature.

In some examples, the forced freeze preparation is performed responsive to determining that it is not possible to perform a freeze preparation at the time of the shutdown of the fuel cell system.

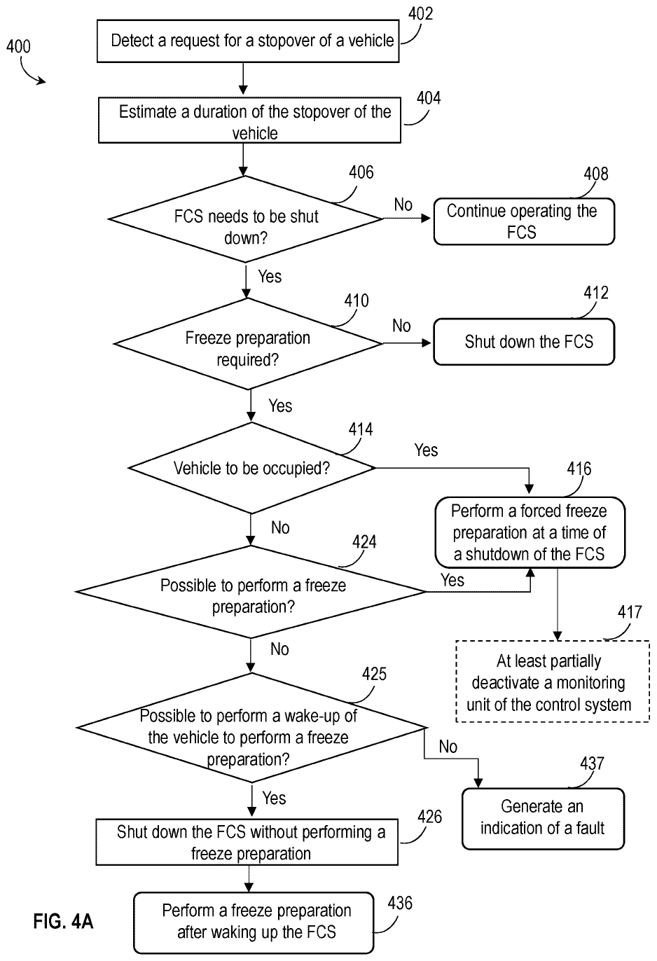

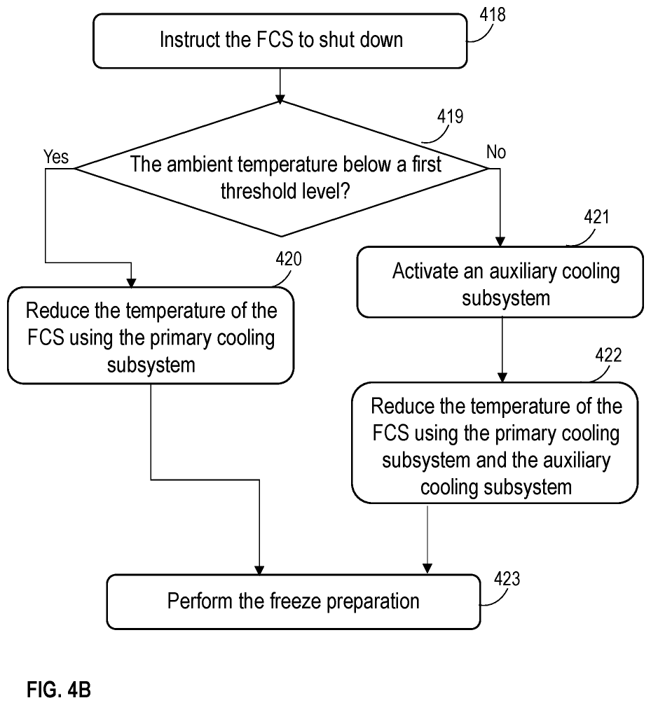

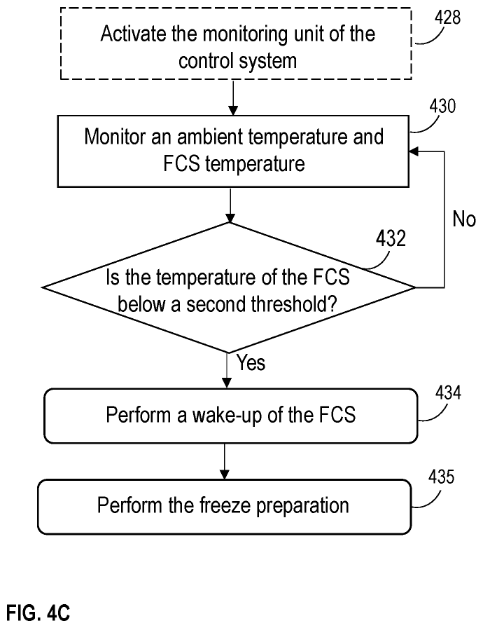

FIGS. 4A, 4B, and 4C illustrate in further detail a method or process 400 of controlling operation of a fuel cell system (FCS) of a fuel cell vehicle such as the vehicle 10 shown in FIGS. 1A and 1B, in accordance with aspects of the present disclosure. The method or process 400 includes acts or steps similar to process 300 the description of which therefore applies to the process 400 and is not repeated in connection with FIGS. 4A, 4B, and 4C. The method or process 400 further illustrates the method of controlling operation of a fuel cell system in accordance with an example of the present disclosure., 4B, and 4C. The method or process 400 may be a computer-implemented method performed by processing circuitry of a control device or system such as e.g. the control system 30, the vehicle controller 35, or the main controller 45 shown in FIGS. 1A, 1B, and 2A.

The process 400 may begin at block 402, when a request for a stop/parking of the vehicle is detected. The processing at block 402 is similar to the processing at block 302 of FIG. 3.

At block 404, the process 400 comprises estimating or determining a duration of a stopover of the vehicle when the request to stop of the vehicle is detected. The processing at block 404 is similar to the processing at block 304 of FIG. 3.

At decision block 406, the control system determines whether the fuel cell system needs to be shut down during the stopover. The processing at block 406 is similar to the processing at block 306 of FIG. 3. The determining is based at least on the duration of the stopover of the vehicle and power needs from the vehicle during the vehicle stopover. The fuel cell system may not need to be shut down when there are energy/power needs, referred to herein as the power needs, from the vehicle during the vehicle stopover and when such power needs cannot be fulfilled by the ESS of the vehicle during the vehicle stopover. Thus, that the fuel cell system needs to remain operational to generate power in accordance with the power needs.

The power needs may be estimated using one or more of ambient conditions, duration of the vehicle stopover as determined at block 404, information on vehicle auxiliary devices that are turned on and/or expected to be turned on during the vehicle stopover, historical data on usage of the vehicle auxiliary devices, and using other data. For example, in cases in which the duration of the vehicle stopover is sufficiently short, it may not be needed to shut down the fuel cell system.

The power needs for a duration of the vehicle stopover may include power needs for power take-off (PTO) devices connected to or installed on the vehicle, such as, e.g., a crane, a refrigerator, an air conditioner, a heater, etc.

At block 408, responsive to determining that the fuel cell system does not need to be shut down (“No”) during the stopover, the control system operates to continue operating the fuel cell system 20. For example, the fuel cell system may continue generating power to fulfill power needs of the vehicle during the stopover.

At decision block 410, responsive to determining that the fuel cell system needs to be shut down (“Yes”) during the stopover, the process 400 comprises determining whether a freeze preparation of the fuel cell system is required during the stopover. This may be determined using data on a current ambient temperature and/or predicted ambient temperature. For example, if it is expected that an ambient temperature, i.e. a temperature the outside or in another environment in which the vehicle is located, falls below 0° C. during the vehicle stopover, it may be determined that the freeze protection is required. It may also be considered for how long the ambient temperature is expected to be below 0° C. Thus, in some examples, the freeze protection may not be required if the ambient temperature is not expected to fall below 0° C., or if it is expected to fall below 0° C. for a time period that is not expected to create a risk of the fuel cell system freezing.

The predicted ambient conditions may be received, e.g., from weather prediction services. For example, the control system may receive information, via a wireless communications network, on a weather forecast indicating that the ambient temperatures will fall below 0° C. during the time the vehicle is expected to remain to be shut down at the current location, i.e. during the stopover of the vehicle. Also, current ambient temperature, which may be determined using, e.g., one or more sensors associated with the vehicle, may be used in determining whether it is required to perform the freeze preparation of the fuel cell system during the stopover of the vehicle.

In some examples, determining whether the freeze preparation of the fuel cell system is required or not is based on the ambient temperature and/or a thermal model of the fuel cell system. In some examples, whether the freeze preparation is required is determined using a thermal model of the fuel cell system and evaluating a heat loss to the surrounding environment, which is a function of an ambient temperature. Thermal models were discussed above, in connection with block 310 (FIG. 3), and similar one or more thermal models of the fuel cell system may be used.

At block 412, responsive to determining that the freeze preparation of the fuel cell system (FCS) is not required (“No”) during the stopover of the vehicle, the fuel cell system may be shut down. This may be performed in any of various ways suitable for the fuel cell system. A sequence of steps may be followed as the control system 30 instructs the fuel cell system to shut down. As a result of the shutdown, the fuel cell system stops generating power and its temperature, i.e. the temperature of the fuel cell stack, begins to decrease.

The freeze preparation of the fuel cell system may not be required, for example, when the ambient temperature of the environment outside the vehicle is not expected to fall below a certain temperature threshold. In some examples, this temperature threshold is about 0° C. In some cases, the vehicle may be parked indoors and in such conditions no freeze preparation may be required.

At decision block 414, responsive to determining that the freeze preparation of the fuel cell system is required (“Yes”) during the stopover of the vehicle, the process 400 comprises determining whether the vehicle is expected to be occupied by a vehicle user during at least part of the duration of the stopover. This processing is similar to the processing at decision block 314. The vehicle user may be a driver of the vehicle that in some circumstances may be using the vehicle for sleeping or resting. Thus, in some examples, the vehicle may be expected to be occupied by the driver during at least part of the duration of the stopover of the vehicle when the driver is sleeping in the vehicle.

Art block 416, responsive to determining that the vehicle is expected to be occupied (“Yes”) by the vehicle user during at least part of the duration of the stopover, the process 400 comprises performing the forced freeze preparation at the time of the fuel cell system shutdown.

When the fuel cell system is shut down, the ESS 40 such as e.g. one or more batteries are used to fulfill the vehicle power/energy needs. In some cases, batteries need to be charged to a higher stated of charge (SoC) before the fuel cell system can be shutdown, to ensure that there is sufficient energy to fulfill the driver/vehicle needs. This will also depend on a size of the one or more batteries.

The processing at block 416 of FIG. 4A is shown in more detail in connection with FIG. 4B. Thus, as shown in FIG. 4B, performing the forced freeze preparation may comprise at block 418, instructing the fuel cell system to shut down.

At decision block 419, it may be determined whether the ambient temperature is below the first threshold level. The first threshold level may also be referred to as a freeze preparation threshold, which is a temperature of the fuel cell system, e.g. of the fuel cell stack, which is required to perform the freeze preparation. In other words, a temperature above the freeze preparation threshold may not be appropriate for a successful completion of a freeze preparation procedure.

At block 420, responsive to determining that ambient temperature is below the first threshold level, the temperature of the fuel cell system may be reduced using the primary cooling subsystem of the cooling system of the vehicle. In this case, the primary cooling subsystem, configured to reduce the temperature of the fuel cell system of the fuel cell system only as low as the ambient temperature, or a few degrees above the ambient temperature, may be sufficient for reducing the temperature of the fuel cell system.

At block 421 of FIG. 4B, responsive to determining that ambient temperature is not below the first threshold level, e.g., equal to or higher than the first threshold level, the control system may activate an auxiliary cooling subsystem of the fuel cell system. In some examples, the control system may selectively activate the auxiliary cooling subsystem, in dependance on whether or not operating the auxiliary cooling subsystem is required to assist the primary cooling subsystem in further cooling the fuel cell system to a level below the ambient temperature. In some examples, however, the auxiliary cooling subsystem may already be operating such that its activation may not be required. Thus, the processing at block 421 may be optional in some cases.

At block 422, with the auxiliary cooling subsystem being activated, the temperature of the fuel cell system may be reduced using both the primary cooling subsystem and the auxiliary cooling subsystem of the cooling system of the fuel cell vehicle. As discussed above, the primary cooling subsystem alone is not able to reduce the temperature of the fuel cell system below the ambient temperature, but when the auxiliary cooling subsystem is activated and operated to assist the primary cooling subsystem in cooling the fuel cell system, the temperature of the fuel cell system may be reduced to below the ambient temperature.

Thus, the temperature of the fuel cell system is reduced using, at block 420, the primary cooling subsystem of the cooling system, or using, at block 422, both the primary cooling subsystem and the auxiliary cooling subsystem of the cooling system.

At block 423, once the temperature of the fuel cell system is reduced to below the first threshold level, the control system performs the freeze preparation of the fuel cell system, by instructing one or more components of the fuel cell system to execute certain acts or processes to prepare the fuel cell system for freeze conditions.

The freeze preparation may be any suitable technique that makes the fuel cell system 20 resilient to freezing conditions. In some examples, residual water is removed from the fuel cell stack 22. For example, in some cases, a medium may be circulated through the fuel cell stack 22 that removes residual moisture from the stack. Other techniques may be used to remove moisture from the fuel cell stack 22. In this way, a risk of degradation and damage of the fuel cell system due to freezing of the water that remains in the fuel cell system when it is shut off is reduced or eliminated.

The control system performs the forced freeze preparation, i.e. controls the fuel cell system, in some cases in combination with other components of the vehicle, to perform the forced freeze preparation at the time of the shutdown of the fuel cell system. As used herein, a time of the shutdown refers to a time that does not necessary exactly coincides with the shutdown of the fuel cell system, but that immediately follows the shutdown, such that the forced freeze preparation is considered to be performed at the time of the shutdown of the fuel cell system. Also, the freeze preparation is considered to be performed at the time of the shutdown of the fuel cell system in contrast to a freeze preparation that may be performed after the fuel cell system has been shut down without performing a freeze preparation, and then woken up to undergo a freeze preparation, e.g. when ambient conditions allow performing the freeze preparation.

It should be appreciated that the processing at the acts of FIG. 4B may be performed in an order that is different from the sequence of the acts shown in FIG. 4B. For example, the auxiliary cooling subsystem may be activated before the fuel cell system is instructed to shut down.

At block 417 of FIG. 4A, optionally, a monitoring unit of the control system may be deactivated. The monitoring unit, such as e.g. the monitoring unit 34 of the control system and/or the monitoring unit 36 of the vehicle control system 35, may be deactivated when it was previously activated or it may be considered deactivated when its activation does not occur. Because the freeze preparation of the fuel cell system has been performed and the fuel cell system is thus protected from a damaging effect of freezing conditions expected during the vehicle stopover, there may be no need to monitor the fuel cell system and conditions around it, such as ambient conditions, to determine whether and when to wake up the fuel cell system. Thus, at least certain functions of the control system, such as those responsible for monitoring the fuel cell system regarding a possibility to waking it up, may be deactivated. In this way, the fuel cell system may be operated in a more energy-efficient manner. Also, not keeping the monitoring unit 34 up and running allows saving energy required to operate the control system, which advantageously allows saving costs.

It should be noted that, in some cases and/or depending on an implementation of the fuel cell system, no monitoring of the fuel cell system regarding waking it up for performing a freeze preparation may be performed. Thus, the monitoring unit of the control system such as the control system 30 and/or the vehicle control system 35 may not be active, may be disabled, or in some cases it may not be present in the control system. In some cases, the control system such as e.g. the vehicle control system 35 is disabled or the power is not supplied to this component, such that may not be possible to perform monitoring of the fuel cell system during the stopover of the vehicle.

At block 424, responsive to determining that that the vehicle is not expected to be occupied (“No”) by the vehicle user during at least part of the duration of the stopover, the control system may determine whether it is possible to perform a freeze preparation of the fuel cell system i.e. at the time of the shutdown of the fuel cell system. It may be determined that the vehicle is not expected to be occupied by the vehicle user during at least part of the duration of the stopover when it is determined that the driver will not sleep in the vehicle during the stopover or a part thereof. In some examples, the determining of whether it is possible to perform the freeze preparation comprises determining whether it is possible to reduce the temperature of the fuel cell system to below a first threshold level. One or both the primary cooling subsystem and the auxiliary cooling subsystems of the cooling system of the vehicle may be used to reduce the temperature of the fuel cell system to below the first threshold level, in dependance on the current and/or predicted ambient temperature. The primary cooling subsystem may be used when it is sufficient to reduce the fuel cell system temperature to the ambient temperature level, and the auxiliary cooling subsystem may additionally be activated and used to further reduce the fuel cell temperature to below the ambient temperature.

The method 400 further comprises, responsive to determining at block 424 that it is possible (Yes) to perform the freeze preparation of the fuel cell system at the time of the shutdown of the fuel cell system, performing the forced freeze preparation at the time of the shutdown of the fuel cell system, at block 416.

At block 425, responsive to determining at block 424 that it is not possible (“No”) to perform the freeze preparation of the fuel cell system at the time of the shutdown of the fuel cell system, the method 400 may determine whether it is possible to subsequently perform a wake-up of the fuel cell system during the stopover to perform the freeze preparation of the fuel cell system.

In some cases, for example, at a certain location and/or when there are other constrains, it may not be possible to monitor a temperature of the fuel cell system and/or ambient conditions such as e.g. the outside temperature, to determine when to wake up the fuel cell system during the stopover to perform the freeze preparation of the fuel cell system. For example, in some cases, one or more components required for monitoring of the fuel cell system may not be powered. As another example, a monitoring for conditions suitable for a wake-up of the fuel cell system and/or one or more components of the vehicle, may be not performed at some locations, e.g., when the vehicle is on a ferry or parked in an enclosed space. In such locations, a freeze preparation may not be allowed to be performed, as performing the freeze preparation may lead to hydrogen emissions and/or may lead to some water being discharged from fuel cell system, which may be undesirable at those locations.

As shown in FIG. 4A, responsive to determining at block 425 that is not possible (“No”) to subsequently perform the wake-up of the fuel cell system during the stopover to perform the freeze preparation of the fuel cell system, the process 400 follows to block 437 where an indication of a fault may be generated. The indication of a fault, or another indication may be generated when the conditions may not be appropriate for both performing a forced freeze preparation at the time of the shutdown of the fuel cell system and for subsequently monitoring the fuel cell system and the ambient conditions after waking up the fuel cell system (after it had been shut down without performing the freeze preparation). Any other action may additionally or alternatively be taken responsive to determining that it is not possible to perform the forced freeze preparation of the fuel cell system and also not possible to subsequently perform the freeze preparation of the fuel cell system after waking up the fuel cell system and/or other components of the vehicle, such as e.g. monitoring unit(s) of one or more control systems. In some examples, an indication to the driver of the vehicle may be generated, and/or an indication to a fleet management controller may be provided when the fuel cell vehicle is part of a fleet of vehicles.

Alternatively, at block 426, responsive to determining that it is possible (“Yes”) to subsequently perform the wake-up of the fuel cell system and to perform the freeze preparation of the fuel cell system, the process 400 comprises shutting down the fuel cell system. Thus, the control system instructs the fuel cell system to shut down, without performing a freeze preparation of the fuel cell system. The control system controls the shutdown of the fuel cell system 20, which may be performed in various ways, depending on a configuration of the fuel cell system and other factors.

The temperature of the fuel cell system and/or ambient conditions may be then monitored to determine whether and when to wake up the fuel cell system to undergo a freeze preparation.

At block 436, the process 400 may comprise subsequently performing a freeze preparation after waking up the fuel cell system. FIG. 4C illustrates processing that may be performed after the fuel cell system has been shut down without performing a freeze preparation at block 436.

In FIG. 4C, at block 428, the monitoring unit of the control system may optionally be activated or reactivated if it was previously deactivated. As discussed above, the monitoring unit may be adapted and configured to monitor the status of the fuel cell system regarding a possibility of waking up the fuel cell system to perform a freeze preparation procedure to thereby prepare the fuel cell system for possible freezing conditions during the vehicle stopover and/or for a possible freeze start-up.

In some examples, a wake-up timer may be activated when the fuel cell system is shut down to, wake up the fuel cell system at a time defined by the wake-up timer. If, once the fuel cell system is brought into an awake mode or state, it is determined that the freeze preparation may be performed, the wake-up timer may be de-activated. If, once the fuel cell system is brought into an awake mode or state, it is determined that the freeze preparation may not be performed, e.g. due to an ambient temperature being not low enough, the wake-up timer may be set or reset, or it may otherwise continue monitoring the temperature of the fuel cell system and/or ambient conditions.

At block 430, the control system monitors an ambient temperature and a temperature of the fuel cell system 20 such as e.g. the fuel cell stack 22 during the stopover of the vehicle, with the fuel cell system being shut down. The temperatures are monitored to determine whether to wake up the fuel cell system to subject it to a freeze protection and preparation. The temperatures may be monitored in real time. The one or both of the ambient temperature and the fuel cell stack temperature may be monitored continuously. In some examples, the control system may acquire measurements from one or more temperature sensors periodically e.g. at certain time intervals. For example, the monitoring unit may acquire measurements obtained by sensors configured to measure a temperature of the fuel cell system and sensors configured to measure an ambient temperature. The temperature of the fuel cell stack 22 may be measured by a sensor positioned in the fuel cell stack 22 or in the vicinity of the fuel cell stack 22, to acquire and communicate the temperature of the fuel cell stack.

The ambient temperature may be monitored by the control system via one or more temperature sensors installed on the vehicle or in association with the vehicle. Also, in addition to alternatively, the control system may receive current and predicted weather information from a remote weather service, e.g. via a wireless communications network.

Regardless of the specific way in which the ambient temperature and the temperature of the fuel cell stack are monitored, the control system employs these measurements to determine whether the conditions are appropriate for waking up the fuel cell system.

At decision block 432, the control system determines, based on the temperature monitoring at block 430, whether the temperature of the fuel cell system is, or is expected to become, below a threshold level, denoted as a second threshold level in FIG. 4C. The determining is performed to assess whether the conditions have become appropriate for performing a freeze preparation.

In some cases, the monitoring of the ambient temperature and of the predicted temperature may be used in combination with one or more thermal models of the fuel cell system to determine whether to activate a wake-up timer of the fuel cell system. Also, the wake-up timer may be adjusted or modified, e.g., if the actual ambient temperature, acquired using the monitoring, is not following the predicted ambient temperature. In some cases, such type of the wake-up timer may be used when a temperature of the fuel cell system is not monitored or is otherwise not available.

During a stop of the vehicle, the temperature of the fuel cell system, due to natural cooldown, may fall to below the second threshold level. The second threshold level may be different than the first threshold level. In some examples, the second threshold level may be lower than the first threshold level. In some examples, the second threshold level may be higher than the first threshold level. Furthermore, in some examples, the second threshold level may be the same as the first threshold level.

Furthermore, in some examples, the processing at block 432 comprises determining, based on the monitored temperatures, that one or both the ambient temperature and the temperature of the fuel cell system are indicative of the conditions appropriate for performing the freeze preparation for the fuel cell system. For example, the ambient temperature, actual and/or predicted, may be such that the temperature of the fuel cell system is soon to decrease to below a third threshold level. For example, if it is detected that the ambient temperature is below or close to a certain threshold level, a temperature value that is close to the second threshold level, it may be indicating that the temperature of the fuel cell system is about to become to be below the second threshold level.

In some examples, the processing at block 432 may comprise determining whether the ambient temperature is below the third threshold level. In some examples, processing at block 432 may comprise determining whether the temperature of the fuel cell system is below the second threshold level and the ambient temperature is below the third threshold level. The third threshold level may be the same as the second threshold level. In some examples, the third threshold level may be lower than the second threshold level. Thus, the ambient temperature will need to a lower temperature than a temperature that is required for the fuel cell system to be in condition for the freeze preparation.

It should be noted that, after the shutdown of the fuel cell system, the temperature of the fuel cell system may decrease due to a natural cooling, i.e. because of the decreased ambient temperature.

Responsive to determining at block 432 that the temperature of the fuel cell system is not below (“No”), the second threshold level, i.e. above the second threshold level, the process 400 may return to block 430 where the temperature of the fuel cell system and the ambient temperature continue to be monitored by the control system. Thus, until it is detected that the fuel cell system i.e. the fuel cell stack has a temperature below the second threshold level, the control system continues acquiring temperature sensor measurements and comparing them to the second threshold level. It should be noted that the ambient temperature and the temperature of the fuel cell system may be monitored in other circumstances as well, including during a normal operation of the fuel cell system. Here, at block 432, these temperatures are monitored to determine whether and when to wake up the fuel cell system and perform a freeze preparation.

The processing at block 430 may continue unless either it is detected that the temperature of the fuel cell system becomes below the second threshold level or until the end of the stopover of the vehicle. In other words, the vehicle starts again at the end of the stopover.

In some cases, the stopover of the vehicle may be terminated before a predicted time of the next start of the vehicle. In some cases, the vehicle may be started before or after the stopover period, as estimated at block 404, has expired. If the vehicle stopover is interrupted, e.g., in response to an input from the driver indicating a start of the vehicle leading to a start of the fuel cell system before an expected start time, the duration of the vehicle stopover becomes, or is set to, zero, and the stopover period is considered expired. In some cases, the start of the vehicle may not lead to the start of the fuel cell system. For example, when the vehicle only needs to be moved a short, e.g., a few hundred meters, distance, e.g., to change its parking position, there may be no need to start the fuel cell system. The start of the vehicle may not lead to the start of the fuel cell system in other circumstances. When the fuel cell system is not started up, its temperature is not increased, and there may still exist a possibility of freezing.

At block 434, in response to determining at block 432 that the temperature of the fuel cell system is below the second threshold level (“Yes”), the control system performs a wake-up of the fuel cell system. The waking up of the fuel cell system may additionally include waking up one or more other components of the vehicle.

At block 435, the control system performs the freeze preparation after the wake-up of the fuel cell system. This freeze preparation may be similar to the forced freeze preparation-for example, the same or a similar sequence of steps may be followed to prepare the fuel cell system for freezing conditions. In some examples, the freeze preparation after the wake-up of the fuel cell system may have some differences as compared to the forced freeze preparation. For example, the duration of the freeze preparation performed after the waking up of the fuel cell system may be different from the forced freeze preparation. Also, the air compressor and some other components of the fuel cell system may be run in a different manner when compared to the forced freeze preparation. Also, the freeze preparation performed after the waking up of the fuel cell system is performed once it is detected that the fuel cell system is sufficiently cool due to natural cooling, whereas the forced freeze preparation depends on one or both the primary and auxiliary cooling subsystems for bringing the fuel cell system temperature to a sufficient low level.

It should be noted that the processing at blocks of each of FIGS. 3, 4A, 4B, and 4C may be performed in any suitable order, as the order of the actions in the blocks is depicted by way of example.

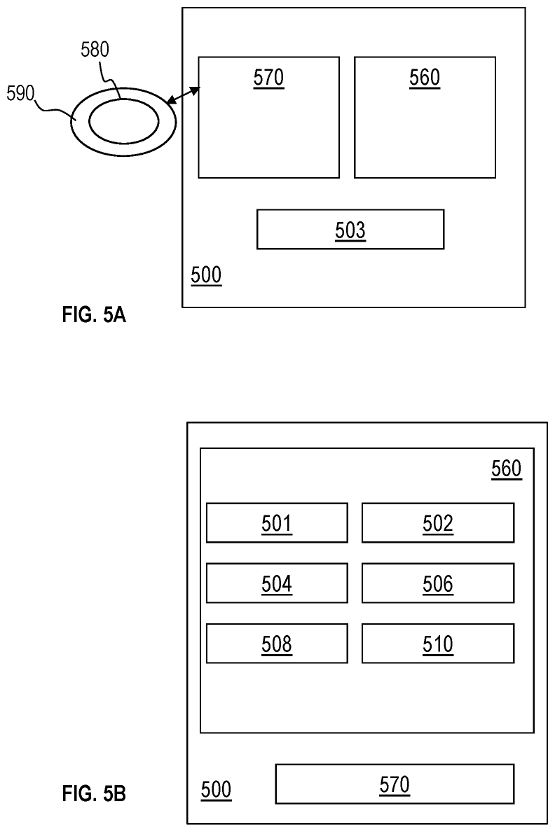

Methods of controlling operation of the fuel cell system as described herein, in accordance with aspects of the present disclosure, may be performed by a control system such as, e.g., one or more of the fuel cell system controller/control system 30, the vehicle controller 35, and the main controller 45 which may in turn be formed by one or more devices or systems. The control system may be part of the fuel cell system or a separate device. FIGS. 5A and 5B additionally illustrate an example of an arrangement of a controller or control system 500 such as e.g., the fuel cell system controller/control system 30, the vehicle controller 35, and/or the main controller 45, for implementing examples disclosed herein. Any one or more of the fuel cell system controller/control system 30, the vehicle controller 35, and the main controller 45 may be implemented as the control system 500 shown in FIGS. 5A and 5B.

As shown in FIG. 5A, the control system 500 of the vehicle 10 comprises processing circuitry 560, memory 570, and an input and output interface 503 configured to communicate with any necessary components and/or entities of examples herein. The input and output interface 503 may comprise a wireless and/or wired receiver and a wireless and/or wired transmitter. In some examples, the input and output interface 503 may comprise a wireless and/or wired transceiver. The control system 500 may be positioned in any suitable location of the vehicle 10. The control system 500 may use the input and output interface 503 to control and communicate with various sensors, actuators, subsystems, and/or interfaces of the fuel cell system and the vehicle 10, by using any one or more out of a Controller Area Network (CAN) bus, ethernet cables, Wi-Fi, Bluetooth, and/or other network interfaces.

The methods described herein may be implemented using processing circuitry, e.g., one or more processors, such as the processing circuitry 560 of the control system 500, together with computer program code stored in a computer-readable storage medium for performing the functions and actions of the examples herein.

The memory 570 may comprise one or more memory units. The memory 570 comprises computer-executable instructions executable by the processing circuitry 560 of the control system 500. The memory 570 is configured to store, e.g., information, data, etc., and the computer-executable instructions to perform, when executed by the processing circuitry 560, the methods in accordance with examples herein. The control system 500 may additionally obtain information from an external memory.

The methods according to the aspects of the present disclosure may be implemented by e.g. a computer program product 580 or a computer program, comprising computer-executable instructions, i.e., software code portions, which, when executed on at least one processor, e.g., the processing circuitry 560, cause the at least one processor to carry out the actions described herein, as performed by the control system 500.

In some examples, the computer program product 580 is stored on a computer-readable storage medium 590. The computer-readable storage medium 590 may be, e.g., a disc, a universal serial bus (USB) stick, or similar device. The computer-readable storage medium 590, having stored thereon the computer program product, may comprise computer-executable instructions which, when executed on at least one processor, e.g., the processing circuitry 560, cause the at least one processor to carry out the actions of the methods in accordance with examples of the present disclosure described herein, as performed by the control system 500.

As shown in FIG. 5B, the control system 500 may comprise a detecting unit 501. The control system 500, the processing circuitry 560, and/or the detecting unit 501 are configured to detect a request for a vehicle stop or parking, also referred to herein as the stopover of the vehicle.

As further shown in FIG. 5B, the control system 500 may comprise an estimating unit 502. The control system 500, the processing circuitry 560, and/or the estimating unit 502 are configured to estimate or determine a duration of a stopover of the vehicle when a request for the stopover of the vehicle is detected. The duration of the stopover may be determined based on one or more out of a location of the vehicle, historical data on operation of the vehicle, and input from a driver of the vehicle.

The control system 500 may comprise a determining unit 504. The control system 500, the processing circuitry 560, and/or the determining unit 504 are configured to determine whether the fuel cell system needs to be shut down during the stopover of the vehicle. This determining is based on one or more out of the duration of the stopover of the vehicle, actual ambient temperature, and predicted ambient temperature.

The control system 500, the processing circuitry 560, and/or the determining unit 504 are further configured to, responsive to determining that the fuel cell system needs to be shut down during the stopover, determine whether a freeze preparation of the fuel cell system is required during the stopover of the vehicle. In some examples, the determining of whether the freeze preparation of the fuel cell system is required during the stopover of the vehicle may be based on an ambient temperature and/or a thermal model of the fuel cell system. The ambient temperature may be an actual ambient temperature and/or predicted ambient temperature.

The control system 500, the processing circuitry 560, and/or the determining unit 504 are further configured to, responsive to determining that the freeze preparation of the fuel cell system is required during the stopover, determine whether the vehicle is expected to be occupied by a vehicle user during at least part of the duration of the stopover of the vehicle.

The control system 500 may comprise a performing unit 506. The control system 30, the processing circuitry 560, and/or the performing unit 506 are configured to, responsive to determining that the vehicle is expected to be occupied by the vehicle user during at least part of the duration of the stopover, perform a forced freeze preparation at a time of the shutdown of the fuel cell system.

In some examples, the control system 500, the processing circuitry 560, and/or the determining unit 504 may be configured to, responsive to determining that the vehicle is not expected to be occupied by the vehicle user during at least part of the duration of the stopover, determine whether it is possible to perform the freeze preparation of the fuel cell system. The control system 500, the processing circuitry 560, and/or the performing unit 506 may be configured to, responsive to determining that it is possible to perform the freeze preparation, perform the forced freeze preparation at the time of the shutdown of the fuel cell system.

In some examples, the control system 500, the processing circuitry 560, and/or the performing unit 506 may be configured to perform the forced freeze preparation at the time of the shutdown of the fuel cell system by instructing the fuel cell system to shut down, reducing the temperature of the fuel cell system below a first threshold level using one or both the primary cooling subsystem and the auxiliary cooling subsystem of the cooling system, and performing the freeze preparation of the fuel cell system.

The control system 500 may comprise an activating/deactivating unit 508. The activating/deactivating unit 508 may be configured to activate or deactivate certain functions of the fuel cell system and other components related to monitoring the status of the fuel cell system during the vehicle stopover. The control system 500, the processing circuitry 560, and/or the activating/deactivating unit 508 may be configured to at least partially deactivate a monitoring unit of the control system 500, and/or any other component of the control system 500. In some cases, the control system 500, the processing circuitry 560, and/or the activating/deactivating unit 508 may be configured to at least partially deactivate one or more components of the fuel cell system and/or one or more components of the fuel cell vehicle comprising the fuel cell system.

In some examples, the control system 500, the processing circuitry 560, and/or the activating/deactivating unit 508 may be configured to activate an auxiliary cooling subsystem of the cooling system of the fuel cell vehicle.

In some examples, the control system 500, the processing circuitry 560, and/or the performing unit 506 may be configured to instruct the fuel cell system to shut down, reducing the temperature of the fuel cell system below the first threshold level using the primary cooling subsystem of the cooling system of the fuel cell vehicle or using both the primary cooling subsystem and the auxiliary cooling subsystem of the cooling system, and performing the freeze preparation of the fuel cell system.

In some examples, the control system 500, the processing circuitry 560, and/or the determining unit 504 may be configured to determine whether it is possible to subsequently, after the fuel cell system has been shut down, perform a wake-up of the fuel cell system during the stopover to perform the freeze preparation of the fuel cell system. In some examples, the control system 500, the processing circuitry 560, and/or the performing unit 506 may be configured to, responsive to determining that it is possible to subsequently perform the wake-up of the fuel cell system to perform the freeze preparation of the fuel cell system, shut down the fuel cell system without performing a freeze preparation.

In some examples, the control system 500, the processing circuitry 560, and/or the activating/deactivating unit 508 may further be configured to activate or deactivate the monitoring unit of the control system. The control system 500, the processing circuitry 560, and/or the activating/deactivating unit 508 may be configured to deactivate the monitoring unit after the freeze preparation of the fuel cell system has been performed. The control system 500, the processing circuitry 560, and/or the activating/deactivating unit 508 may be configured to activate the monitoring unit of the control system to monitor one or more out of a temperature of the fuel cell system, an ambient temperature and any other parameters, while the fuel cell system is shut down without performing the freeze preparation at the time of the shutdown.

In some examples, the control system 500, the processing circuitry 560, and/or the performing unit 506 may further be configured to, responsive to determining that it is possible to subsequently perform the wake-up of the fuel cell system to perform the freeze preparation of the fuel cell system, shut shown the fuel cell system without performing a freeze preparation.

The control system 500 may comprise a monitoring unit 510 which may be the same or similar to the monitoring unit 34 of the control system 30 and/or monitoring unit 36 of the vehicle control system 35. The control system 500, the processing circuitry 560, and/or the monitoring unit 510 may be configured to monitor an ambient temperature, a temperature of the fuel cell system, a temperature of a coolant in the cooling system, and any other parameters, e.g., by acquiring and processing sensor measurement data collected by one or more temperature sensors.

In some examples, the control system 500, the processing circuitry 560, and/or the determining unit 504 may further be configured to determine, based on the monitoring performed by the monitoring unit 510, whether the temperature of the fuel cell system is below a second threshold level. The control system 500, the processing circuitry 560, and/or the determining unit 504 may further be configured to, responsive to determining that the temperature of the fuel cell system is below the second threshold level, perform a wake-up of the fuel cell system, and perform the freeze preparation after the wake-up of the fuel cell system.

In some examples, the control system 500, the processing circuitry 560, and/or the performing unit 506 may further be configured to, responsive to determining that the fuel cell system does not need to be shut down during the stopover, continue operating the fuel cell system. In other words, the fuel cell system is not instructed to shut down.

In some examples, the control system 500, the processing circuitry 560, and/or the performing unit 506 may further be configured to, responsive to determining that the fuel cell system needs to be shut down during the stopover and responsive to determining that the freeze preparation of the fuel cell system is not required during the stopover, shut down the fuel cell system.

Those skilled in the art will appreciate that the control system 500 and units that may be present in the control system 500, may refer to a combination of analogue and digital circuits, and/or one or more processors that may be configured with software and/or firmware that, when executed by the respective one or more processors, may carry out the actions or steps of the method(s) in accordance with the present disclosure. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip. In some examples, the control system 500 may be implemented as a computer system.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A fuel cell vehicle comprising:
a fuel cell system comprising a fuel cell stack;
a cooling system comprising a primary cooling subsystem configured to reduce a temperature of the fuel cell stack to an ambient temperature, and an auxiliary cooling subsystem configured to assist the primary cooling subsystem to reduce the temperature of the fuel cell stack to below the ambient temperature; and
a control system comprising processing circuitry configured to:
estimate a duration of a stopover of the vehicle when a request for the stopover of the vehicle is detected;
determine whether the fuel cell system needs to be shut down during the stopover;
responsive to determining that the fuel cell system needs to be shut down during the stopover, determine whether a freeze preparation of the fuel cell system is required during the stopover;
responsive to determining that the freeze preparation of the fuel cell system is required during the stopover, determine whether the vehicle is expected to be occupied by a vehicle user during at least part of the duration of the stopover; and
responsive to determining that the vehicle is expected to be occupied by the vehicle user during at least part of the duration of the stopover, perform a forced freeze preparation of the fuel cell system at a time of the shutdown of the fuel cell system.

2. The fuel cell vehicle of claim 1, wherein the processing circuitry is further configured to, responsive to determining that the vehicle is not expected to be occupied by the vehicle user during at least part of the duration of the stopover:
determine whether it is possible to perform the freeze preparation of the fuel cell system; and
responsive to determining that it is possible to perform the freeze preparation, perform the forced freeze preparation at the time of the shutdown of the fuel cell system.

3. The fuel cell vehicle of claim 1, wherein performing the forced freeze preparation at the time of the shutdown of the fuel cell system comprises:
instructing the fuel cell system to shut down;
reducing the temperature of the fuel cell system below a first threshold level using one or both the primary cooling subsystem and the auxiliary cooling subsystem of the cooling system; and
performing the freeze preparation of the fuel cell system.

4. The fuel cell vehicle of claim 1, wherein the processing circuitry is further configured to at least partially deactivate a monitoring unit of the control system and/or at least partially deactivate a monitoring unit of a vehicle control system of the fuel cell vehicle.

5. The fuel cell vehicle of claim 2, wherein the processing circuitry is further configured to, responsive to determining that it is not possible to perform the freeze preparation of the fuel cell system:
determine whether it is possible to subsequently perform a wake-up of the fuel cell system during the stopover to perform the freeze preparation of the fuel cell system.

6. The fuel cell vehicle of claim 5, wherein the processing circuitry is further configured to, responsive to determining that it is possible to subsequently perform the wake-up of the fuel cell system to perform the freeze preparation of the fuel cell system, shut down the fuel cell system without performing a freeze preparation.

7. The fuel cell vehicle of claim 6, wherein the processing circuitry is further configured to:
monitor an ambient temperature and a temperature of the fuel cell system, with the fuel cell system being shut down;
determine, based on the monitoring, whether the temperature of the fuel cell system is below a second threshold level; and
responsive to determining that the temperature of the fuel cell system is below the second threshold level,
perform a wake-up of the fuel cell system, and
performing the freeze preparation after the wake-up of the fuel cell system.

8. The fuel cell vehicle of claim 1, wherein determining whether the freeze preparation of the fuel cell system is required during the stopover of the vehicle is based on a predicted and/or current ambient temperature and/or a thermal model of the fuel cell system.

9. The fuel cell vehicle of claim 1, wherein the duration of the stopover of the vehicle is determined based on one or more out of a location of the vehicle, historical data on operation of the vehicle, and input from a driver of the vehicle.

10. The fuel cell vehicle of claim 1, wherein the processing circuitry is further configured to, responsive to determining that the fuel cell system needs to be shut down during the stopover and responsive to determining that the freeze preparation of the fuel cell system is not required during the stopover, shut down the fuel cell system.

11. A method of controlling operation of a fuel cell system of a fuel cell vehicle, the method comprising:
estimating a duration of a stopover of the vehicle when a request for the stopover of the vehicle is detected;
determining whether the fuel cell system needs to be shut down during the stopover;
responsive to determining that the fuel cell system needs to be shut down during the stopover, determining whether a freeze preparation of the fuel cell system is required during the stopover;
responsive to determining that the freeze preparation of the fuel cell system is required during the stopover, determining whether the vehicle is expected to be occupied by a vehicle user during at least part of the duration of the stopover; and
responsive to determining that the vehicle is expected to be occupied by the vehicle user during at least part of the duration of the stopover, performing a forced freeze preparation of the fuel cell system at a time of the shutdown of the fuel cell system.

12. The method of claim 11, further comprising, responsive to determining that the vehicle is not expected to be occupied by the vehicle user during at least part of the duration of the stopover:
determining whether it is possible to perform the freeze preparation of the fuel cell system; and
responsive to determining that it is possible to perform the freeze preparation, performing the forced freeze preparation at the time of the shutdown of the fuel cell system.

13. The method of claim 11, wherein performing the forced freeze preparation at the time of the shutdown of the fuel cell system comprises:
instructing the fuel cell system to shut down;
reducing the temperature of the fuel cell system below a first threshold level using a primary cooling subsystem of a cooling system of the fuel cell vehicle or using both the primary cooling subsystem and an auxiliary cooling subsystem of the cooling system of the fuel cell vehicle; and
performing the freeze preparation of the fuel cell system.

14. The method of claim 11, further comprising at least partially deactivating a monitoring unit of the control system and/or at least partially deactivating a monitoring unit of a vehicle control system of the fuel cell vehicle.

15. The method of claim 12, further comprising, responsive to determining that it is not possible to perform the freeze preparation of the fuel cell system:
determining whether it is possible to subsequently perform a wake-up of the fuel cell system during the stopover to perform the freeze preparation of the fuel cell system.

16. The method of claim 15, further comprising, responsive to determining that it is possible to subsequently perform the wake-up of the fuel cell system to perform the freeze preparation of the fuel cell system, shutting down the fuel cell system without performing a freeze preparation.

17. The method of claim 16, further comprising:
monitoring an ambient temperature and a temperature of the fuel cell system, with the fuel cell system being shut down;
determining, based on the monitoring, whether the temperature of the fuel cell system is below a second threshold level; and
responsive to determining that the temperature of the fuel cell system is below the second threshold level,
performing a wake-up of the fuel cell system, and
performing the freeze preparation after the wake-up of the fuel cell system.

18. The method of claim 11, wherein determining whether the freeze preparation of the fuel cell system is required during the stopover of the vehicle is based on a predicted and/or current ambient temperature and/or a thermal model of the fuel cell system.

19. The method of claim 11, wherein the duration of the stopover of the vehicle is determined based on one or more out of a location of the vehicle, historical data on operation of the vehicle, and input from a driver of the vehicle.

20. A control system for controlling the fuel cell system of the fuel cell vehicle, the control system comprising processing circuitry that is configured to perform a method of claim 11.

21. A fuel cell system comprising the control system of claim 20.

22. A computer program product comprising instructions, which, when executed by processing circuitry, cause the processing circuitry to perform the method of claim 11.

23. A computer-readable storage medium, having stored thereon a computer program product comprising instructions which, when executed by processing circuitry, cause the processing circuitry to perform a method of claim 11.
